(19) United States
(12) Patent Application Publication
(10) Pub. No.: US 2008/0218574 A1
(43) Pub. Date: Sep. 11, 2008

(54) Ink-jet recording method and ink-jet recording apparatus

(75) Inventors: Kumiko Furuno, Tokyo (JP); Hisashi Mori, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 12/072,839

(22) Filed: Feb. 28, 2008

(30) Foreign Application Priority Data
Mar. 8, 2007 (JP) JP2007-058478

(51) Int. Cl. B41J 2/01

(52) U.S. Cl. 347/100; 347/102; 347/103

(57) ABSTRACT

An ink-jet recording method of recording an image on a recording medium by jetting from a line head type ink-jet recording head ink droplets which are curable by being irradiated with active energy rays, comprises steps of conveying step of conveying the recording medium in a conveying direction; jetting ink droplets to form first ink dots on the recording medium; irradiating active energy rays onto the first ink dots formed on the recording medium; jetting ink droplets having the same color as that of the first ink dots at a downstream position of the first jetting step in terms of the conveying direction to form second ink dots so as to partially overlap on the first ink dots; and irradiating active energy rays onto the second ink dots formed on the recording medium.

This application is based on Japanese Patent Application No. 2007-058478 filed on Mar. 8, 2007 in Japanese Patent Office, the entire content of which is hereby incorporated by reference.

### BACKGROUND OF THE INVENTION

The present invention relates to an ink-jet recording method using ink-jet ink containing an active energy ray curable compound (also, referred as an actinic radiation curable compound).

An ink-jet recording method can record a high definition image with a relatively simple apparatus, and it has accomplished rapid developments in every field. Moreover, the usages of the ink-jet recording method are expanded over various different fields, and various kinds of recording mediums and ink-jet inks have been used for respective usages.

In particular, in recent years, improvements of the ink-jet recording method to make speed higher and image quality higher have attracted attention, and from the viewpoint that an ink-jet recording head tends to have many nozzles, the recording width of the head has been expanded. Such an ink-jet recording head is called line head (refer the official gazette of Japanese Patent Unexamined Publication No. 6-183029). A large improvement in the recording speed has been attained by the adoption of such a line head type ink-jet recording head, and an ink-jet printer equipped with a performance sustainable the usage of a printing business has being developed.

However, when an ordinary water base ink-jet ink is used to record an image on print sheets having a low ink absorbability, such as art paper and coated paper which are mainly used in offset printing and gravure printing, or on plastic film having absolutely no ink absorbability, there has been a problem called color bleeding in which ink liquids having respective different hues are mixed with each other on a recording medium causing color muddiness.

Proposed (refer the descriptions of U.S. Pat. No. 4,390,369 and U.S. Pat. No. 4,484,948) in order to solve the above-mentioned problem is a hot melt type ink-jet recording method which uses a hot-melt-type ink composition made from solid state wax in a room temperature, liquefies the composition with heat, jets the liquid by applying a certain energy, adheres the liquid on a recording medium, and simultaneously cools and solidifies the liquid so as to form a record dot.

Since this hot-melt-type ink is a solid at a room temperature, it does not become soil at the time of handling. Further, since the ink substantially does not cause ink evaporation at the time of being melt, it does not cause clogging of nozzles. Furthermore, since it can solidify promptly after adhering on a recording medium, it also does not cause color blur. Therefore, it is said that the hot-melt-type ink is an ink composition capable of providing good printing quality regardless of quality of paper. However, in the image recorded by the above method, since ink dots of the ink are formed by soft wax, there are problems such as deterioration of image quality due to the embossment of the ink dots and lack of resistance for friction.

On the other hand, U.S. Pat. No. 4,228,438 discloses ink for an ink-jet recording, which can be cured or hardened by being irradiated with active energy rays. Further, there is a so called nonaqueous type ink which contains pigments as a coloring material, polyacrylate having three or more functions as a polymerizable material and ketone or alcohol as a main solvent. Furthermore, Japanese Patent Unexamined Publication No. 2002-80767 discloses a water base active energy ray curable ink composition for ink-jet recording which includes a polyurethane compound containing a group having an active energy ray curable unsaturated double bond, a basic compound, a colorant, a water soluble organic solvent and water. Moreover, Japanese Patent Unexamined Publication No. 2002-275404 discloses a water base ink-jet ink which includes a self-dispersing type pigment in which one or more sorts of hydrophilic groups are bonded on the surface of pigment grains, a ultraviolet ray curable monomer consisting of a vinyl compound, a photopolymerization initiator and water.

However, in the case where an image is formed with the ink-jet ink including the ray curable resin by the use of a line head, before an ink droplet jetted out from the line head onto a recording medium is fixed by being irradiated with light rays, since another ink droplet to form a neighboring dot reaches onto the recording medium, ink droplets of the neighboring dots come close to each other and the coming-close of the ink droplets causes a new problem of banding which forms band-like unevenness or streak unevenness on, especially, a solid image of the same color formed with a large amount of jetted ink.

On the other hand, as a method to improve beading generated between neighboring dots, Japanese Patent Unexamined Publication No. 6-115100 discloses an ink-jet recording method which prints one line by dividing one line printing operation into four scanning operations. However, in an imaging region formed with a large amount of jetted ink, since the fixation of ink droplets of dots to a recording medium is insufficient before ink droplets of neighboring dots reach the recording medium, and the above-mentioned problems have not been yet solved.

### SUMMARY OF THE INVENTION

The present invention has been made in view of the above-mentioned theme or problem, an object of the present invention is to improve a banding resistance and a bleeding resistance in the same color print in a line head printing method and to provide an ink-jet recording method and an ink-jet recording apparatus capable of performing an image recording excellent in glossiness.

The abovementioned object of the present invention can be attained by the following methods and structure.
Item 1. An ink-jet recording method of recording an image on a recording medium by jetting from a line head type ink-jet recording head ink droplets which are curable by being irradiated with active energy rays, comprises:

a conveying step of conveying the recording medium in a conveying direction;

a first jetting step of jetting ink droplets to form first ink dots on the recording medium;

a first irradiating step of irradiating active energy rays onto the first ink dots formed on the recording medium;

a second jetting step of jetting ink droplets having the same color as that of the first ink dots at a downstream position of the first jetting step in terms of the conveying direction to form second ink dots so as to partially overlap on the first ink dots; and

a second irradiating step of irradiating active energy rays onto the second ink dots formed on the recording medium.
Item 2. The ink-jet recording method described in Item 1, wherein the first ink dots are formed in the direction perpendicular to the conveying direction at the first jetting step such that the first ink dots are not overlapped to each other and the second ink dots are formed on the gaps among the first ink dots so as to form line-shaped ink dots in the direction perpendicular to the conveying direction.
Item 3. The ink-jet recording method described in Item 1, wherein the first ink dots are formed in the conveying direction at the first jetting step such that the first ink dots are not overlapped to each other and the second ink dots are formed on the gaps among the first ink dots so as to form line-shaped ink dots in the conveying direction.
Item 4. The ink-jet recording method described in Item 1, wherein the first jetting step and the second jetting step form line-shaped ink dots in the conveying direction respectively.
Item 5. The ink-jet recording method described in Item 1, wherein the arrangement of the first ink dots formed in the direction perpendicular to the conveying direction at the first jetting step is deviated by 0.5 pitch from the arrangement of the second ink dots formed in the direction perpendicular to the conveying direction at the second jetting step.
Item 6. The ink-jet recording method described in Item 1, wherein the first jetting step superimposes at least two different color inks so as to form first color-mixed ink dots, the first irradiating step irradiates active energy rays onto the first color-mixed ink dots, the second jetting step forms second color-mixed ink dots having the same color as that of the first mixed ink dots at positions adjacent to the first color-mixed ink dots, and the second irradiating step irradiates active energy rays onto the second color-mixed ink dots.
Item 7. The ink-jet recording method described in Item 1, wherein the ink droplets include water and a polymeric compound which is curable or crosslinkable by being irradiated with active energy rays.
Item 8. The ink-jet recording method described in Item 7, wherein the polymeric compound is a polymeric compound which has plural side chains on a hydrophilic main chain and is able to crosslink between the side chains by being irradiated with active energy rays.
Item 9. The ink-jet recording method described in Item 8, wherein in the polymeric compound, the hydrophilic main chain is a saponified product of polyvinyl acetate, the degree of saponification is 77% to 99%, and the degree of polymerization is 200 to 500.
Item 10. The ink-jet recording method described in Item 8, wherein in the polymeric compound, the modification rate of the side chains to the hydrophilic main chain is 0.8 mol% or more and 5 mol % or less.
Item 11. The ink-jet recording method described in Item 8, wherein the polymeric compound further includes a photopolymerization initiator.
Item 12. The ink-jet recording method described in Item 1, wherein the ink droplets correspond to at least one kind ink constituting an ink-jet ink set consisting of two or more kinds of ink-jet inks different in hue.
Item 13. The ink-jet recording method described in Item 1, wherein the recording medium is a low absorptivity recording medium or an unabsorbent recording medium.
Item 14. The ink-jet recording method described in Item 1, further comprising:

a heating step of heating the recording medium from the back side of the recording medium during recording or before and after recording.
Item 15. An ink-jet recording apparatus for recording an image on a recording medium by jetting ink droplets which are curable by being irradiated with active energy rays, comprising:

a conveying section to convey the recording medium in a conveying direction;

a first line head to jet ink droplets so as to form first ink dots on the recording medium;

a first irradiating section to irradiate active energy rays onto the first ink dots formed on the recording medium;

a second line head to jet ink droplets having the same color as that of the first ink dots at a downstream position of the first line head in terms of the conveying direction to form second ink dots so as to partially overlap on the first ink dots; and

a second irradiating section to irradiate active energy rays onto the second ink dots formed on the recording medium.
Item 16. The ink-jet recording apparatus described in Item 15, wherein the first line head forms the first ink dots in the direction perpendicular to the conveying direction such that the first ink dots are not overlapped to each other and the second line head forms the second ink dots on the gaps among the first ink dots so as to form line-shaped ink dots in the direction perpendicular to the conveying direction.
Item 17. The ink-jet recording apparatus described in Item 15, wherein the first line head forms the first ink dots in the conveying direction such that the first ink dots are not overlapped to each other and the second line head forms the second ink dots on the gaps among the first ink dots so as to form line-shaped ink dots in the conveying direction.
Item 18. The ink-jet recording apparatus described in Item 15, wherein the first line head and the second line head form line-shaped ink dots in the conveying direction respectively.
Item 19. The ink-jet recording apparatus described in Item 15, wherein the arrangement of the first ink dots formed in the direction perpendicular to the conveying direction by the first line head is deviated by 0.5 pitch from the arrangement of the second ink dots formed in the direction perpendicular to the conveying direction by the second line head.
Item 20. The ink-jet recording apparatus described in Item 15, wherein the first line head includes at least two different color ink line heads and the second line head includes color ink line heads having the same colors of the first line head.
Item 21. The ink-jet recording apparatus described in Item 15, wherein the conveying section includes a conveying belt.
Item 22. The ink-jet recording apparatus described in Item 15, wherein the conveying section includes a rotatable drum.
Item 23. The ink-jet recording apparatus described in Item 15, wherein a common line head and a common irradiating section are mounted on the rotatable drum, and wherein during the first rotation of the rotatable drum, the common line head and the common irradiating section act as the first line head and the first irradiating section and form the first ink dots, and subsequently during the second rotation of the rotatable drum, the common line head and the common irradiating section act as the second line head and the second irradiating section and form the second ink dots.
Item 24. The ink-jet recording apparatus described in Item 15, further comprising:

a heating section to heat the recording medium from the back side of the recording medium during recording or before and after recording.

According to the above methods and structures, the present invention can provide an image recording method and an image recording apparatus capable of improving the banding resistance and bleeding resistance among the same color ink dots in a line head printing method and performing an image recording excellent in glossiness.

Incidentally, in the present invention, ink droplets that have reached on a recording medium and formed dots are called ink dots.

### BRIEF DESCRIPTION OF THE DRAWINGS

FIG. 1 is an outline top view showing an example of an ink-jet printer in which an ink-jet recording head unit which consists of a plurality of ink-jet recording heads and a light irradiating device are arranged.

FIG. 2 is a schematic diagram showing an example of dot arrangements at the time of performing image formation.

FIG. 3(a) is a side view showing an example of an ink-jet printer in which a plurality of ink-jet recording head units and a plurality of light irradiating devices are arranged, and FIG. 3(b) is an outline top view of the ink-jet printer shown in FIG. 3(a).

FIG. 4 is an outline top view showing an example of an ink-jet printer which a plurality of ink-jet recording heads and a plurality of light irradiating devices are arranged alternately respectively.

FIG. 5 is an outline top view showing an example of an ink-jet printer which a plurality of ink-jet recording head units and a plurality of light irradiating devices are arranged alternately respectively.

FIG. 6 is a bottom view showing a relationship of nozzle locations between ink-jet recording head units.

FIG. 7 is a side view showing an example of a printing drum type ink-jet printer.

### DETAILED DESCRIPTION OF THE PREFERRED EMBODIMENT

The preferable embodiments of the present invention will be explained herein after. However, the present invention is not limited to these embodiments.

Hereafter, the best mode for carrying out the present invention will be explained in detail.

The present invention has been achieved by the intensive study that, in an ink-jet recording method which record on a recording medium by jetting ink-jet ink from an ink-jet recording head, with the ink-jet recording method characterized in that this ink-jet recording head is a line head type, the method comprises a process to irradiate active energy rays two times or more separately after jetting the ink-jet ink onto the recording medium, and the method jets the same color ink-jet ink separately two times or more, the following effects have been found that the banding resistance and bleeding resistance among the same color ink dots in a line head printing method can be improved, and an ink-jet recording method which performs image recording excellent in glossiness can be realized.

Further, explaining in detail, in the ink-jet recording method which jets out ink-jet ink from an ink-jet recording head, and records on a recording medium; the present invention is characterized in that the ink-jet ink has characteristics of being curable by being irradiated with active energy rays, and the method comprises a process to irradiate active energy rays two times or more separately after jetting the ink-jet ink onto the recording medium by the use of a line head type ink-jet recording head and the method jets the same color ink-jet ink separately two times or more.

Usually, when an image formation is performed by the use of a line head type ink-jet recording head, in the case where an image is printed with a large amount of jetted ink, especially on a solid image portion formed with the same color ink, there are themes that so-called a banding phenomenon in which striped patterns are caused in perpendicular or in parallel to the printing direction easily take place. In comparison with a serial type ink-jet recording apparatus, a line head type ink-jet recording apparatus is characterized in that since neighboring same color ink dots reach with a very short time interval onto a recording medium, before the shape of a preceding ink dot having previously reached on the recording medium is fixed or cured, another ink droplet reaches at a neighboring ink dot of the preceding ink dot. Therefore, the banding phenomena is a specific problem of the line head type ink-jet recording apparatus to be solved.

As a result of an intensive study for these themes by the inventor, it has been fund that the banding phenomenon can be eliminated with the ink-jet method to irradiate active energy rays at least one time during a time period after an ink droplet of the first shot of the same color ink-jet ink have reached and formed an ink dot on the recording medium until another ink droplet of the second shot reaches at a position next to the ink dot of the first shot on the recording medium.

The reason for the above elimination has not been certain. However, it has been assumed that since an ink dot of ink droplet is fully fixed on a recording medium or on an ink dot of an already jetted-out ink droplet by being irradiated with light rays before another ink droplet reaches at a position of a neighboring ink dot, ink droplets are prevented from coming close to each other among ink dots of the same color, whereby the banding can be improved.

Furthermore, it has been found that even if conditions, such as time from the reaching of ink droplet to the irradiating for the ink droplet and time the reaching of ink droplet to the reaching of another ink droplet for the neighboring ink dot, are the same, the banding phenomenon caused by the mixture of ink droplets among the same color on a recording medium influences severely more on an image than the color bleeding caused by the mixture of ink droplets among different colors on a recording medium when the image formed on the recording medium with the ink-jet recording is visually observed.

Namely, in comparison with a method of jetting ink droplets of the same color with a short time interval of several hundreds and irradiating finally active energy rays, the both of good bleeding resistance and banding resistance can be realized by a method of jetting ink droplets separately two times or more and by irradiating each ink droplet with active energy rays during a time period of from several hundreds milliseconds to several seconds before anther ink droplet reaches at the neighboring ink dot.

Incidentally, the term “neighboring dots” used in the present invention is defined as two dots adjoining along the conveying direction, two dots adjoining along the direction perpendicular to the conveying direction, or four dots combined with them.

Moreover, the ink-jet ink preferably applied to the ink-jet recording method of the present invention contains water and a photoactive resin being curable or able to crosslink by being irradiated with active energy rays.

The reasons for the above are as follows: Since a water base ultraviolet curable ink-jet ink has low viscosity, when ink droplets of this type ink-jet ink of the same color reach neighboring ink dots, the ink droplets come close to each other within a very short time so as to cause banding. Therefore, by the application of the ink-jet recording method of the present invention to this water base ultraviolet curable ink-jet ink, the banding can be suppressed effectively.

Further, as the photoactive resin, by the use of a polymeric compound (hereafter, referred as active energy ray cross-linkable high molecules) which has plural side chains for a hydrophilic main chain and is able to cause cross-linking bonds between the side chains by being irradiated with active energy rays, the above effect of the method of the present invention can be significantly recognized even in a region onto where a large amount of jetted ink reaches.

The reasons for the above are estimated as follows: since the ink including active energy ray cross-linkable macromolecules increase viscosity rapidly upon irradiation with light rays, this action makes it possible to fix ink droplet on a recording medium before another ink droplet of the same color reaches at a neighboring ink dot. Furthermore, by the application of heat onto the rear face of a recording medium, the leveling ability of ink droplets between ink dots can be improved, whereby glossiness becomes well.

Hereafter, the present invention will be explained in detail.

### <<Ink-Jet Recording Method>>

As mentioned above, the ink-jet recording method of the present invention is characterized by employing a line head type ink-jet recording head, having a process to irradiate active energy rays two times or more separately after jetting the ink-jet ink onto the recording medium, and jetting the same color ink-jet ink separately two times or more.

### (Ink-Jet Printer)

In an ink-jet printer which can be used in the ink-jet recording method of the present invention, mainly, an image forming section is arranged to be horizontal or parallel to a recording medium, and the image forming section is structured with a line head type ink-jet recording head to jet ink-jet ink from jetting ports of nozzles toward a recording medium and a light source to irradiate active energy rays (when a plurality of ink-jet inks are used, a plurality of ink-jet recording heads are used).

In the ink-jet recording method of the present invention, it is characterized in that after an ink droplet of ink-jet ink is jetted and reaches to a recording medium, the ink-jet recording method has a process to irradiate active energy rays at least one time before another ink droplet of the same color reaches to neighboring ink dots. With this, it is possible to refrain banding caused by the action that ink droplets of the same color are mixed to each other.

Hereafter, a concrete recording method will be explained. However, the present invention is not limited to this embodiment.

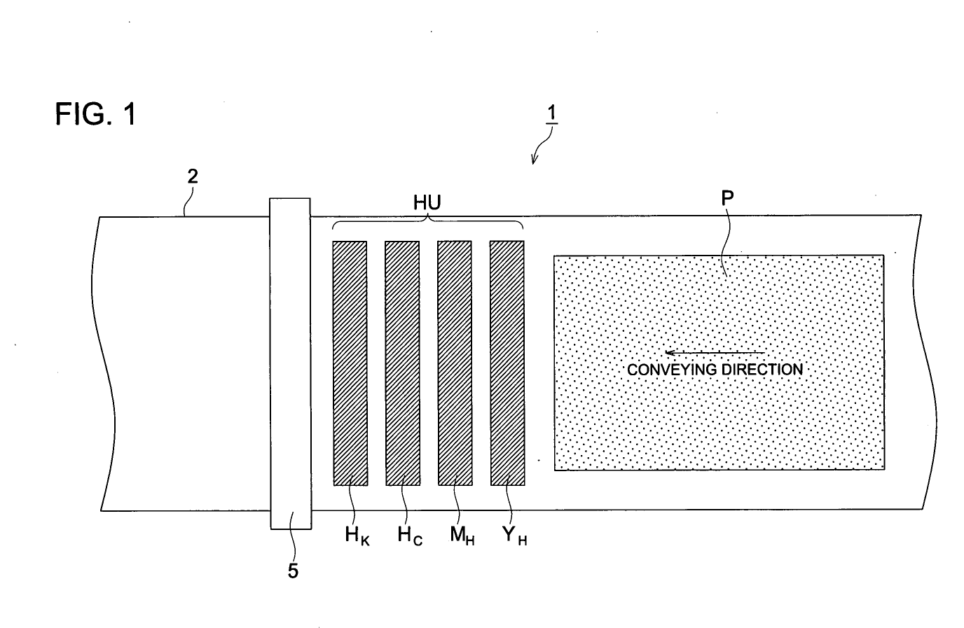

FIG. 1 is an outline top view showing an example of an ink-jet printer as a comparative example in which an ink-jet recording head unit structured with a plurality of ink-jet recording heads and the light irradiating device are arranged.

In FIG. 1, provided on a platen 2 to hold a recording medium P, is an ink-jet printer 1 comprising an ink-jet recording head unit HU to mount an ink set composed of two or more kinds of ink thereon and a light irradiating device 5 arranged at the downstream of the ink-jet recording head unit HU. The ink-jet recording head unit HU is constituted by line head type ink-jet recording heads HY, HM, HC, and HK, that is, FIG. 1 shows an example of an ink set constituted by yellow ink, magenta ink, cyan ink, and black ink. In this regard, as the ink set, an ink set constituted by two or more inks or an ink set constituted by a monochromatic ink may be employed.

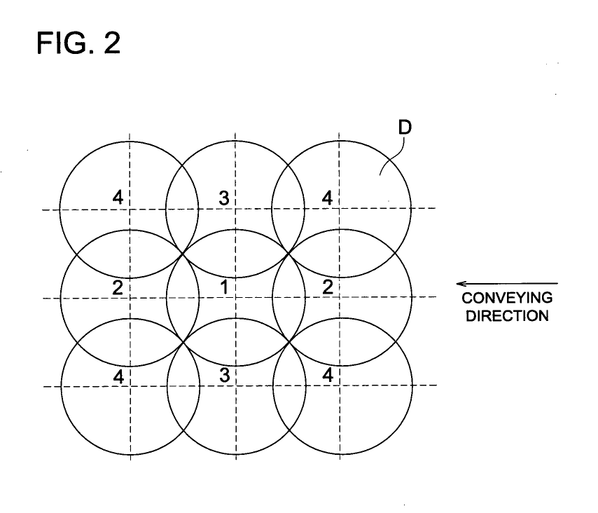

Subsequently, a printing order (ink droplet reaching order) of each ink by the use of the ink-jet printer 1 structured as shown in FIG. 1 will be explained with reference to FIG. 2.

FIG. 2 is a schematic diagram showing an example of an arrangement of each ink dot (printing position for each ink dot) at the time of performing an image formation.

As an ink droplet reaching order of each ink dot D onto a recording-medium in the case where the same color image is formed along a line in a direction perpendicular to the conveying direction on a recording medium by the use of the ink-jet printer 1 shown in FIG. 1, fundamentally, ink dots 1 and ink dots 3 or ink dots 2 and ink dots 4 shown in FIG. 2 are almost simultaneously jetted out to the recording medium. Therefore, there may be the fear or risk that the banding takes place between the neighboring ink dots 1 and ink dots 3 and also between the neighboring ink dots 2 and ink dots 4. Further, since the ink-jet printer 1 shown in FIG. 1 has only one ink-jet recording head for the same one color, when the same color image is formed in the conveying direction, ink droplets are jetted to the succeeding ink dots 2 without irradiating active energy rays onto the ink droplets on the preceding ink dots 1. Therefore, there may be the fear or risk that the banding takes place between these neighboring ink dots 1 and ink dots 2. In the same way, there may be the fear or risk that the banding takes place between these neighboring ink dots 3 and ink dots 4. Incidentally, the ink droplet reaching time difference between the ink dots 1 and the ink dots 2 and the ink droplet reaching time difference between the ink dots 3 and the ink dots 4 are determined by the difference between the locations where each ink-jet recording head is arranged and the conveying speed for a recording medium. For example, under the assumption that the conveying speed is 350 mm/sec, the ink droplet reaching time difference between the ink dot 1 and the ink dot 2 and the ink droplet reaching time difference between the ink dot 3 and the ink dot 4 become in general several tens microseconds to several hundreds microseconds, although it will change depending on the resolution of an image and the distances from the ink-jet recording heads HK, HC, HM, and HY to the light irradiating source of the light irradiating device 5.

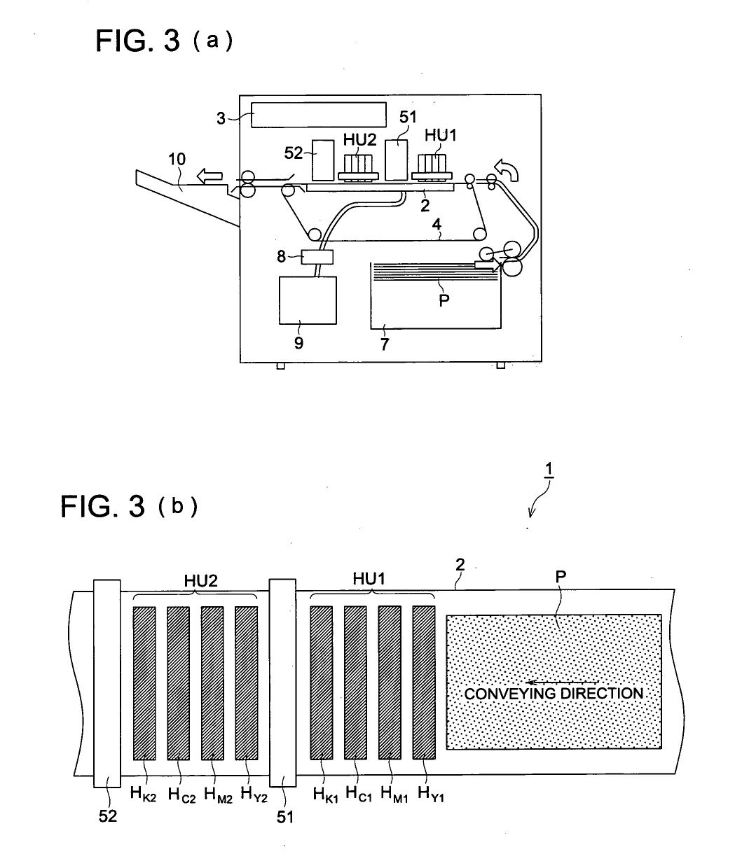

FIG. 3 is an outline top view showing an example of an ink-jet printer of the present invention in which a plurality of ink-jet recording head units and a plurality of light irradiating devices are arranged.

An ink-jet printer 1 shown in FIG. 3 has two ink-jet recording head units HU1 and HU2 each consisting of a plurality of ink-jet recording heads corresponding to the ink set on the platen 2 to hold a recording medium P, and two light irradiating devices 51 and 52 are arranged at respective positions at the downstream of each of the ink-jet recording head units HU1 and HU2. The ink-jet recording head unit HU1 and the ink-jet recording head unit HU2 preferably have the same resolution. The nozzle locations of the ink-jet recording head unit HU1 and the nozzle locations of the ink-jet recording head unit HU2 may be arranged to deviate from each other by 0.5 pitch along the direction perpendicular to the conveying direction or may be arranged to become equal to each other along the direction perpendicular to the conveying direction. When the nozzle locations of the ink-jet recording head unit HU1 and the nozzle locations of the ink-jet recording head unit HU2 are arranged to deviate from each other by 0.5 pitch along the direction perpendicular to the conveying direction, a recording image having the resolution of two times of that of the ink-jet recording head units HU1 and HU2 can be obtained. Whereby there are merits in the point of the size of the recording apparatus and the cost. However, the effect of the present invention exhibits more remarkably when the nozzle locations of the ink-jet recording head unit HU1 and the nozzle locations of the ink-jet recording head unit HU2 are arranged to become equal to each other along the direction perpendicular to the conveying direction. A recording medium P fed out from a sheet feeding section 7 is conveyed on a platen 2 by a conveying belt 4 while being kept its flatness. Ink droplets are jetted out onto the recording medium P from the ink-jet recording heads H_{K1}, H_{C1}, H_{M1}, and H_{Y1} constituting the ink-jet recording head unit HU1, thereafter the ink droplets having reached to the recording medium P are irradiated with active energy rays by the light irradiating device 51 arranged at the downstream of the ink-jet recording head unit HU1. Successively, ink droplets are jetted out from the ink-jet recording heads HK2, HC2, HM2, and HY2 constituting the ink-jet recording head unit HU2, thereafter the ink droplets having reached to the recording medium P are irradiated with active energy rays by the light irradiating device 52 arranged at the downstream of the ink-jet recording head unit HU2. Here, an ink set 1 mounted on the ink-jet recording head unit HU1 and an ink set 2 mounted on the ink-jet recording head unit HU2 may be an ink set composed of two or more kinds of inks or an ink set composed of a monochromatic ink, however, the ink set 1 and the ink set 2 preferably have the same color ink. The same color ink means an ink containing the same kind of coloring materials. After each ink droplet having reached on the recording medium P is irradiated with active energy rays by the light irradiating device 52, the recording medium P is discharged onto a tray 10. Incidentally, unnecessary ink adhered on the platen 2 is discharged by a pump 9 through a gas liquid separating section. In the examples shown in FIG. 3, a sheet shaped recording medium P is used. However, a roll-shaped recording medium may be also used in the present invention.

Subsequently, the printing order (ink droplet reaching order) of each ink by the use of the ink-jet printer 1 shown in FIG. 3 will be explained with reference to FIG. 2.

In the first method to make ink droplet reach onto a recording medium, firstly, ink droplets are made to reach to ink dots 2 and ink dots 3 shown in FIG. 2 by the ink-jet recording head unit HU1, and the ink droplets having reached are once cured by being irradiated with active energy rays by the light irradiating device 51. Thereafter, ink droplets are made to reach to ink dots 1 and ink dots 4 shown in FIG. 2 by the ink-jet recording head unit HU2, and the ink droplets having reached are cured by being irradiated with active energy rays by the light irradiating device 52. With the adoption of such the ink droplet reaching order, for example, when the conveying speed is 350 mm/sec, the ink droplet reaching time difference between the ink dot 1 and the ink dot 2 and the ink droplet reaching time difference between the ink dot 3 and the ink dot 4 can be adjusted to be several hundreds microseconds, although it will change depending on the distances from the ink-jet recording heads to the light source. The resolution of the image obtained by this method becomes equal to the resolution of the ink-jet recording head unit HU1 and the ink-jet recording head unit HU2. As a result, it becomes possible to carry out light irradiation one time before another ink droplets of the same color ink by the ink-jet recording head unit HU2 reach to neighboring ink dots, and an amount of ink jetted during a short time period can be reduced, whereby the effect of refraining bleed becomes higher.

On the other hand, in the second method to make ink droplet reach onto a recording medium, firstly, ink dots 1 and ink dots 4 shown in FIG. 2 are formed by the ink-jet recording heads HY1 and HCl of the ink-jet recording head unit HU1 and ink dots 2 and ink dots 3 shown in FIG. 2 are formed by the ink-jet recording heads HM1 and HK1. Then, the ink droplets having reached are once cured by being irradiated with active energy rays by the light irradiating device 51. Thereafter, ink dots 2 and ink dots 3 which are shown in FIG. 2 are formed by the ink-jet recording heads HY2 and HC2 of the ink-jet recording head unit HU2 and ink dots 1 and ink dots 4 shown in FIG. 2 are formed by the ink-jet recording heads HM2 and HK2. Then, the ink droplets having reached are cured by being irradiated with active energy rays by the light irradiating device 52. With the adoption of such the ink droplet reaching order, for example, when the conveying speed is 350 mm/sec, the ink droplet reaching time difference between the ink dot 1 and the ink dot 2 and the ink droplet reaching time difference between the ink dot 3 and the ink dot 4 can be adjusted to be several hundreds microseconds, although it will change depending on the distances from the ink-jet recording heads to the light source. The resolution of the image obtained by this method becomes equal to the resolution of ink-jet recording head unit HU1 and ink-jet recording head unit HU2. As a result, it becomes possible to carry out light irradiation one time before another ink droplets of the same color ink reach to neighboring ink dots, and the maximum ink amount of jetted ink of an image formed by the ink-jet recording head unit HU1 can be reduced, whereby the banding resistance of a solid image in a region having received a much amount of jetted ink such as the same color image becomes good.

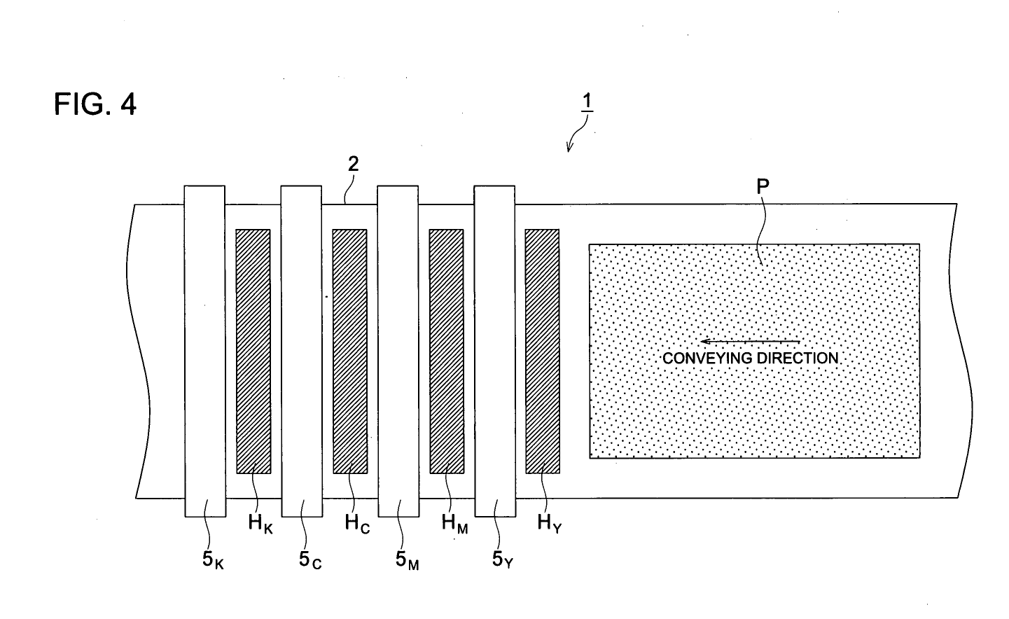

FIG. 4 is an outline top view showing an example of an ink-jet printer as a comparative example in which a plurality of ink-jet recording heads and a plurality of light irradiating devices are arranged alternately.

In an ink-jet printer 1 shown in FIG. 4, ink-jet recording heads HK, HC, HM, and HY are arranged sequentially in the conveying direction on a platen 2 to hold a recording medium P, and also the light irradiating devices 5K, 5C, 5M, and 5Y are arranged respectively at the downstream of corresponding ink-jet recording heads so as to serve as respective pairs.

Subsequently, the printing order (ink droplet reaching order) of each ink by the use of the ink-jet printer shown in FIG. 4 will be explained with reference to FIG. 2.

As an ink droplet reaching order of each ink dot D onto a recording-medium in the case where the same color image is formed along a line in a direction perpendicular to the conveying direction on the recording medium by the use of the ink-jet printer 1 shown in FIG. 4, fundamentally, ink dots 1 and ink dots 3 or ink dots 2 and ink dots 4 shown in FIG. 2 are almost simultaneously jetted out to a recording medium from respective ink recording heads as same as the ink-jet printer 1 shown in FIG. 1. Therefore, there may be the fear or risk that the banding takes place between the neighboring ink dots 1 and ink dots 3 and also between the neighboring ink dots 2 and ink dots 4. Further, since the ink-jet printer 1 shown in FIG. 1 has only one ink-jet recording head for the same one color, when the same color image is formed in the conveying direction, ink droplets are jetted to the succeeding ink dots 2 without irradiating active energy rays onto the ink droplets on the preceding ink dots 1. Therefore, there may be the fear or risk that the banding takes place between these neighboring ink dots 1 and ink dots 2. In the same way, there may be the fear or risk that the banding takes place between these neighboring ink dots 3 and ink dots 4. Incidentally, the ink droplet reaching time difference between the ink dots 1 and the ink dots 2 and the ink droplet reaching time difference between the ink dots 3 and the ink dots 4 are determined by the conveying speed of the recording medium. For example, when the conveying speed is 350 mm/sec, the ink droplet reaching time difference between the ink dots 1 and the ink dots 2 and the ink droplet reaching time difference between the ink dots 3 and the ink dots 4 become several tens microseconds to several hundreds microseconds, although it will change depending on the resolution of an image and the distances from the ink-jet recording heads to the light source.

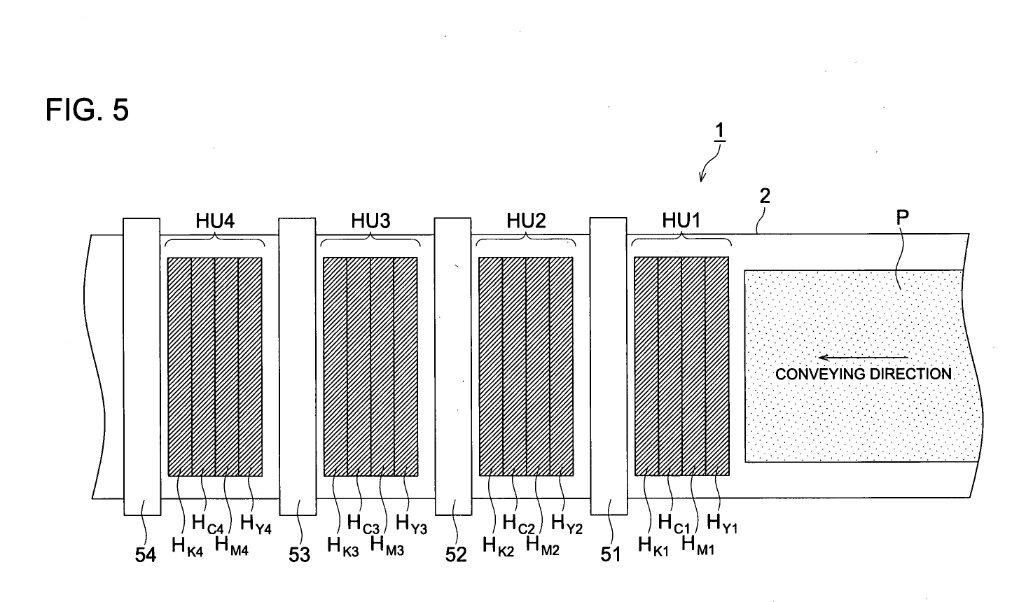

FIG. 5 is an outline top view showing an example of an ink-jet printer of the present invention in which a plurality of ink-jet recording head units and a plurality of light irradiating devices are arranged alternately.

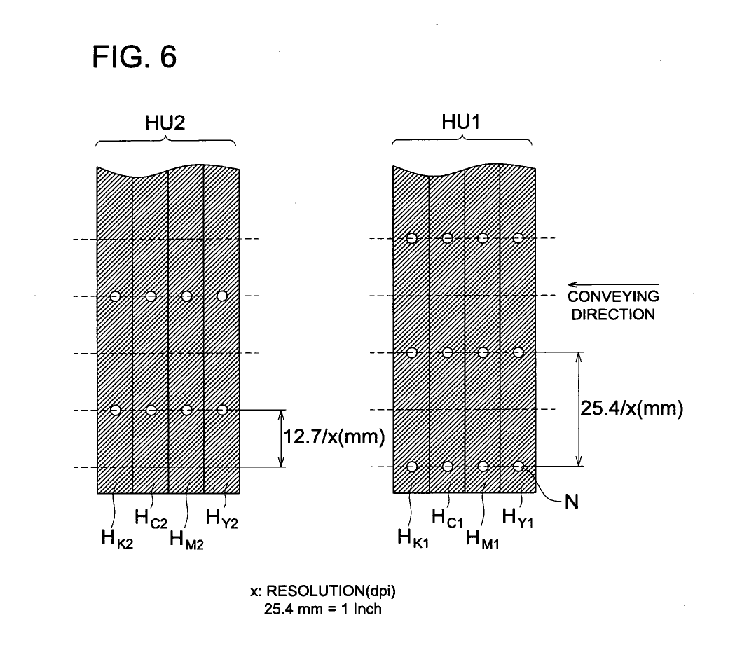

In an ink-jet printer 1 shown in FIG. 5, an ink-jet recording head unit HU1 structured with ink-jet recording heads HK1, HC1, HM1, and HY1, an ink-jet recording head unit HU2 structured with ink-jet recording heads HK2, HC2, HM2, and HY2, an ink-jet recording head unit HU3 structured with ink-jet recording heads HK3, HC3, HM3, and HY3, and an ink-jet recording head unit HU4 structured with ink-jet recording heads HK4, HC4, HM4, and HY4, are arranged sequentially in the conveying direction on a platen 2 to hold a recording medium P, and also the light irradiating devices 51, 52, 53, and 54 are arranged respectively at the downstream of corresponding ink-jet recording head units so as to serve as respective pairs. Each of the ink-jet recording heads constituting the ink-jet recording head units HU1 through HU4 has the same resolution. The ink-jet recording head units HU1 and the ink-jet recording head units HU4, and the ink-jet recording head units HU2 and the ink-jet recording head units HU3 are arranged such that the nozzle locations become equal to each other along the direction perpendicular to the conveying direction. Further, as shown in FIG. 6, the nozzle pitch of the ink-jet recording head units HU1 is preferably deviated by half pitch in the direction perpendicular to the conveying direction from that of the ink-jet recording head units HU2.

FIG. 6 is an illustration showing a relationship of the nozzle locations between ink-jet recording head units.

Concretely, FIG. 6 shows an arrangement of each nozzle N of the ink-jet recording head units HU 1 and the ink-jet recording head units HU2 when being viewed from the bottom side. For example, under the assumption that the resolution of each ink-jet recording head unit is x (dpi), the nozzle location interval of each ink-jet recording head unit becomes 25.4/x (mm). Therefore, it is desirable that nozzle positions of each ink-jet recording head constituting the ink-jet recording head unit HU1 and the ink-jet recording head unit HU2 are arranged to deviate by the half pitch, that is, 12.7/x (mm).

In the printing method by the use of an ink-jet printer 1 shown in FIG. 5, firstly, the ink-jet recording head unit HU1 jets out ink droplets, and then the light irradiating device 51 performs a curing process. Subsequently, the ink-jet recording head unit HU2 jets out ink droplets, and then the light irradiating device 52 performs a curing process. Subsequently, the ink-jet recording head unit HU3 jets out ink droplets, and then the light irradiating device 53 performs a curing process. Finally, the ink-jet recording head unit HU4 jets out ink droplets, and then the light irradiating device 54 performs a curing process. Here, an ink set mounted on each of the ink-jet recording head units may be an ink set composed of two or more kinds of inks or an ink set composed of a monochromatic ink, however, an ink set mounted on each ink-jet recording head unit preferably has the same color ink respectively.

Subsequently, although the printing order (ink droplet reaching order) of each ink by the use of the ink-jet printer 1 shown in FIG. 5 will be explained with reference to FIG. 2, this shows an example in the present invention, the present invention is not limited to the ink droplet reaching order shown here.

First, ink dots 1 shown in FIG. 2 are printed by the ink-jet recording head unit HU1, and are irradiated with active energy rays. Thereafter, ink dots 4 shown in FIG. 2 are printed by the ink-jet recording head unit HU2, and are irradiated with active energy rays. Thereafter, ink dots 3 shown in FIG. 2 are printed by the ink-jet recording head unit HU3, and are irradiated with active energy rays. Finally, ink dots 2 shown in FIG. 2 are printed by the ink-jet recording head unit HU4, and are irradiated with active energy rays, whereby an image formation is completed.

In an image recording by the use of the ink-jet printer shown in FIG. 5, for example, when the conveying speed is 350 mm/sec, the ink droplet reaching time difference between the ink dot 1 and the ink dot 4 and the ink-droplet reaching time difference between the ink dot 2 and the ink dot 3 can be adjusted to be several hundreds microseconds, although it will change depending on the distances from the ink-jet recording heads to the light source, and during this period, it is possible to conduct light irradiation one time. The resolution of the image obtained by this method becomes two times of the resolution of the ink-jet recording head unit HU1.

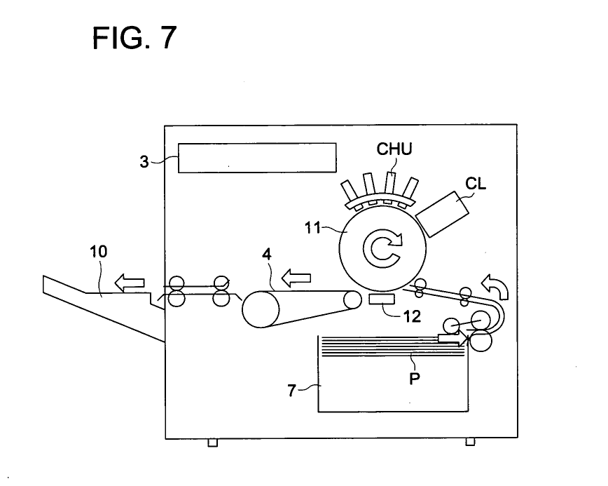

The ink-jet recording method of the present invention is not limited to the ink-jet recording method by the ink-jet printer shown in FIG. 3, or the ink-jet recording method by the ink-jet printer shown in FIG. 5. For example, as shown in FIG. 7, a drum printing method capable of conducting scanning printing and irradiating light rays two times or more may be one of desirable ink-jet recording methods applicable with the present invention.

In the ink-jet printer shown in FIG. 7, a recording medium P fed out from a sheet feeding section 7 by a conveying roller is fixed on a drum 11 with air suction or electrostatic adsorption. The recording medium P is conveyed to a position opposite to an ink-jet recording head unit CHU with the rotation of the drum at the first time, and then the ink-jet recording head unit CHJ jets ink droplets onto the recording medium P so that the first dots are formed on the recording medium P. Successively, the first dots formed on the recording medium P are irradiated with active energy rays by a light irradiating device CL. Next, with the rotation of the drum at the first time, the recording medium P is conveyed again to the position opposite to the ink-jet recording head unit CHU, and then the ink-jet recording head unit CHU jets ink droplets onto the recording medium P in such a way that the second dots are formed at positions adjacent to the first dots on the recording medium P. Successively, the second dots formed on the recording medium P are irradiated with active energy rays by the light irradiating device CL. Thereafter, the recording medium P is subjected to electric charge elimination by a charge eliminating section 12, separated from the drum 11, conveyed by a conveying belt 4 and discharged onto a tray 10. With this method, the ink-jet recording head unit CHU and the light irradiating device CL act as a plurality of ink-jet recording head unit and a plurality of light irradiating devices in accordance with the plural number of rotations of the drum 11. Therefore, since the number of ink-jet recording head unit and light irradiating devices can be reduced, the recording apparatus can be made compact and the cost can be reduced. Incidentally, in this method, a plural sheets of recording medium can be fixed on the drum 11 in accordance with the diameter of the drum 11. Further, the ink-jet recording head unit can form image while shifting on the drum 11 in the axial direction of the drum 11 for each rotation of the drum 11.

In the ink-jet recording method of the present invention, examples of active energy rays irradiated to ink droplets having reached onto a recording medium includes electron rays, ultraviolet rays, α rays, β rays, y rays, X-rays, etc., electron rays and ultraviolet rays which have little danger to a human body, can be handled easily and has been utilized widely in an industrial field are preferable. Especially, ultraviolet rays are preferable in the present invention.

When electron rays are used, an amount of irradiated electron rays with is preferably within a range of 0.1 to 30 Mrad. When the amount is not more than 0.1 Mrad, a sufficient irradiation effect may not be obtained. On the other hand, when the amount exceeds 30 Mrad, there may be a possibility that a support etc. may be deteriorated.

When ultraviolet rays are used, as a light source, for example, well-known one, such as a low-pressure, medium-pressure, and high-pressure mercury lamp having a working pressure from several hundreds Pa to 1 MPa, a metal halide lamp, a xenon lamp with a luminous wavelength in an ultraviolet region, a cold cathode tube and a hot cathode tube, and LED, are used.

As irradiating conditions for active energy rays, active energy rays are preferably irradiated within 0.01 to 5.0 seconds after ink droplets reach on a recording medium. In order to form a high definition image, it becomes important especially to make an irradiation timing early as much as possible.

In the ink-jet recording method of the present invention, with regard to a method of controlling time after ink droplets reach on a recording medium until active energy rays are irradiated by an active energy ray irradiating light source, the method can control the time by adjusting suitably a distance between the active energy ray irradiating light source and the nozzles of the ink jet recording head and the recording speed. Moreover, in the present invention, it is still more desirable to heat the rear face of a recording medium during a printing process or before and behind the printing process. As a heating process, there may be a method of bringing a recording medium in contact with a heating roller or a flat heater and can be chosen them suitably. The desirable range of heating temperature is 30 degrees or more and 70 degrees or less. If the recording medium is heated to 30 degrees or more, the glossiness of printing quality becomes good, on the other hand, if the recording medium is heated to 70 degrees or less, there will be no deformation of the recording medium, and the conveyance performance of recording medium is good.

In the present invention, a drying process may be provided after the process of irradiating active energy rays. Although there is no restraint in particular as the drying process given after the process of irradiating light, for example, a drying method of bringing the rear face of a recording medium in contact with a heating roller or a flat heater; a method of blowing warm air on a printing face with a dryer; a method of removing volatile components by a pressure reducing process; or a method of drying with electromagnetic waves such microwave may be employed with an appropriately selected one or in combination of them.

### (Printer Member)

As a printer member incorporated in an ink-jet printer for use in the ink-jet recording method of the present invention, in order to prevent a head surface from being irradiated with active energy rays, for example, due to the diffuse reflection of ultraviolet rays, a member with low permeability and reflectance to active energy rays is desirable.

Moreover, as the active energy ray irradiating unit, a type mounted with a shutter thereon is desirable. For example, when ultraviolet rays are used, the ratio of the illumination at the time of shutter opening to the illumination at the time of shutter closing is 10 or more, preferably 100 or more, more preferably 10000 or more.

### (Ink Jet Recording Head)

In the ink-jet recording method of the present invention, ink-jet ink according to the present invention is jetted out to a recording medium by the used of an ink-jet recording head so as to form an image. As the ink-jet recording head used in the ink-jet recording method of the present invention, any one of the on demand type and the continuous type may also usable. Further, as jetting methods, electric-machine conversion types (for example, a single cavity type, a double cavity type, a vendor type, a piston type, a share mode type, and a shared wall type etc.); electric-thermal conversion types (for example, a thermal ink jet type, a bubble jet type (registered trademark), etc.); electrostatic suction types (for example, an electric-field-control type, a slit jet type, etc.), an electrically discharging type (for example, a spark jet type etc.), etc. may be listed as a concrete example, and any one of the above types can be employed.

### (Line Head Type Ink-Jet Recording Head)

Moreover, the ink-jet recording method of the present invention is characterized by using as a printing type a line head type ink-jet recording head being required severely against clogging. The line type ink-jet recording head is an ink-jet recording head with a longer size more than the width of a recording medium. As line type ink-jet recording head, a longer size head having a large number of nozzles, or an elongated head structured with a unit of a plurality of ink-jet recording heads may be preferably used.

In comparison with a serial head in which a carriage to carry a recording head scans in the direction perpendicular to the direction to convey a recording medium so as to form an image, a large number of records can be made in a short time by the use of the line type ink-jet recording head, whereby productivity can be improved significantly.

### <<Ink Jet Ink>>

Next, ink-jet ink according to the present invention will be explained.

### [Photoreactive Resin]

Ink-jet ink (hereafter, merely referred to as ink) according to the present invention is an ink containing a compound (hereafter, merely referred to as a photoreactive resin) which is curable or crosslinkable by being irradiated with active energy rays.

As the photoreactive resin, for example, a polymerizable monomer, a polymerizable oligomer and etc. may be used. Preferable examples of the polymerizable monomer include radical polymerizable monomers and cationic polymerizable monomers. It is also desirable to use together a monofunctional monomer, a bifunctional monomer or a multifunctional monomer of trifunctional or more. As a photo radical initiator and a photo cationic initiator, conventionally well-known initiators may be used.

The effects of the present invention are satisfactorily demonstrated in a water base ultraviolet curable ink-jet ink. As the water base ultraviolet curable ink-jet ink, an ink containing emulsion in which polymerizable oligomers are dispersed in water may be usable.

In the present invention, preferably usable as the photoreactive resin, is a polymeric compound (hereafter, referred also as an active energy ray cross-linkable polymer) which has plural side chains on a hydrophilic main chain and is capable of causing crosslinking bonds between the side chains by being irradiated with active energy rays. Hereafter, the active energy ray cross-linkable polymer will be explained.

Examples of the polymeric compound of the present invention which has plural side chains on a hydrophilic main chain (backbone) and is capable of causing crosslinking bonds between the side chains by being irradiated with active energy rays, include a compound in which a modifying group such as a photo-dimerizing group, a photo-decomposing group, a photo-polymerizing group, a photo-modifying group or a photo-depolymerizing group is introduced into side chains of at least one kind of hydrophilic resins selected from a group consisting of a saponified polyvinyl acetate product, polyvinyl acetal, polyethylene oxide, polyalkylene oxide, polyvinyl pyrrolidone, polyacrylamide, polyacrylic acid, hydroxyethyl cellulose, methyl cellulose, hydroxypropyl cellulose, derivatives of the above hydrophilic resins and their copolymers.

As the side chains, nonionic side chains, anionic side chains, or amphoteric side chains (a betaine compound) are desirable. Especially, when being combined with an anionic pigment as colorant, nonionic side chains or anionic side chains may be preferable from the viewpoint of storage stability, and nonionic side chains may be more preferable.

As the hydrophilic resin, saponified polyvinyl acetate may be desirable from the viewpoints of easiness for introducing of side chains and handling, the saponification degree is desirably 77% or more and 99% or less. Moreover, the average polymerization degree is desirably 200 or more and 4000 or less, more desirably 200 or more and 1800 or less from the viewpoint of handling, further, the effects of the present invention can be exhibited still more preferably in a range of 200 or more and 500 or less. When the average polymerization degree is 200 or more, the effect of viscosity increase by desiccation exhibits moderately and bleeding of the second color at the time of using a line head type becomes good. Further, when the average polymerization degree is 500 or less, the jetting ability after the stop of jetting for a given time, that is, so-called an intermittently-jetting ability becomes good. Incidentally, the average polymerization degree can be calculated in accordance with the method specified in Japanese Industrial Standards K 6726.

The additive amount of the hydrophilic resin is preferably 1 mass % or more and 10 mass % or less to the total amount of ink. When the additive amount is 1 mass % or more, since the viscosity of the ink increases sufficiently at the time of being irradiated with light rays, a good bleeding resistance may be acquired. On the other hand, when the additive amount is 10 mass % or less, the viscosity of the ink can be adjusted so as to be proper for the characteristics of an ink jet recording head, and the velocity lowering of an initial ink droplet after the stop of jetting for a given time becomes small.

The denaturation ratio (modification ratio) of side chains to a hydrophilic main chain is desirably 0.8 mol % or more and 4.0 mol % or less, and more desirably 1.0 mol % or more and 3.5 mol % or less from the viewpoint of reactivity. When it is 0.8 mol % or more, a sufficient fixability may be acquired, and when it is 4.0 mol % or less, preservation stability becomes good.

Preferably used as the photo-dimerizable type denaturalizing group, is a group into which a diazo group, a cinnamoyl group, a stilbazonium group, a stilquinolium group, etc. is introduced. For example, a light sensitive resin (composition) described in Japanese Unexamined Patent Publication No. 60-129742 official gazette may be used desirably.

The light sensitive resin (composition) described in Japanese Unexamined Patent Publication No. 60-129742 official gazette is the compound represented by the following Formula (1) in which a stilbazonium group is introduced into a polyvinyl alcohol structure.

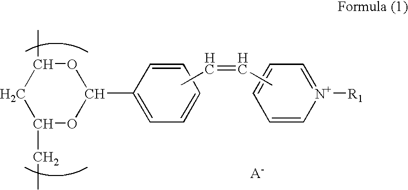

In the formula, R₁ represents an alkyl group having a carbon number of 1 to 4, and A⁻ represents a counter anion.

The light-sensitive resin described in Japanese Unexamined Patent Publication No. 56-67309 is a resin composition having 2-azido-5-nitrophenylcarbonyloxyethylene structure representing by the following Formula (2) or a 4-azido-3-nitrophenycargonyloxyethylene structure represented by the following Formula (3) in a polyvinyl alcohol structure:

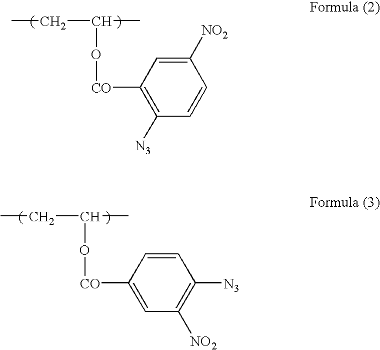

Further, the modifying group represented by the following Formula (4) is also preferably used:

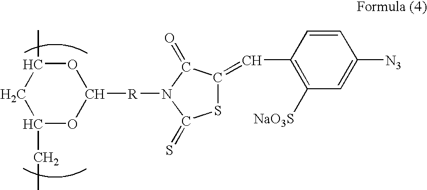

In the formula, R is an alkylene group or an aromatic ring, and preferably a benzene ring.

As a photopolymerizable type modifying group, a resin described in Japanese Unexamined Patent Publication Nos. 2000-181062 and 2004-189841 and represented by the following Formula (5) is also preferrable from the viewpoint of reactivity.

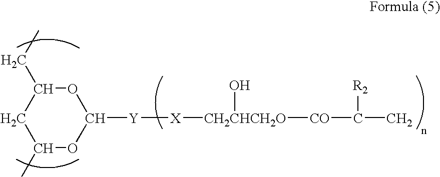

In the formula, R₂ represents a methyl group or a hydrogen atom; n is 1 or 2; X represents —(CH₂)ₘ—COO— or —O—; Y represents an aromatic ring or a single bond; and m is an integer of 0 to 6.

A photopolymerizable type modifying group described in Japanese Unexamined Patent Publication No. 2004-161942 and represented by the following Formula (6) is preferably usable in a conventionally known water-soluble resin:

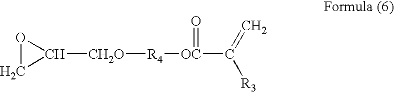

In the formula, R₃ represents a methyl group or a hydrogen atom; and R₄ represents a straight chain or branched alkylene group.

In the ink according to the invention, a photopolymerization initiator may be preferably employable. The compound may be in the condition of being dissolved or dispersed in a solvent, or being chemically bonded to a photosensitive resin.

An employable water-soluble photopolymerization initiator is not limited specifically, however, 4-(2-hydroxyethoxy)phenyl-(2-hydroxy-2-propyl)ketone (HMPK), thioxanthon ammonium salt (QTX) and benzophenone ammonium salt (ABQ) are preferably used as the initiator from the view points of miscibility with aqueous solvents and reaction efficiency.

Furthermore, from the viewpoint of compatibility with resin, compounds represented by the following Formula (7), such as 4-(2-hydroxyethoxy)phenyl-(2-hydroxy-2-propyl)ketone (n=1, HMPK) and its ethylene oxide adduct (n=2-5) are more preferable.

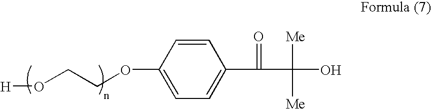

wherein n is an integer of 1 to 5.

Furthermore, examples of other preferred photopolymerization initiators include benzophenones such as benzophenone, hydroxybenzophenone, bis-N,N-dimethylaminobenzophenone, bis-N,N-diethylaminobenzophenone and 4-methoxy-4′-dimethylaminobenzophenone; thioxanthones such as thioxanthone, 2,4-diethylthioxantone, isopropylthioxantone, chlorothioxanthone and isopropoxychlorothioxanthone; anthraquinones such as ethylanthraquinone, benzanthraquinone, aminoanthraquinone, and chloroanthraquinone; acetophenones; benzoin ethers such as benzoin methyl ether; 2,4,6-trihalomethyltriazines; 1-hydroxycyclohexylphenyl ketone; 2,4,5-triarylimidazole dimmers such as 2-(o-chlorophenyl)-4,5-diphenylimidazole dimmer, 2-(o-chlorophenyl)-4,5-di-(m-methoxyphenyl)imidazole dimmer, 2-(o-fluorophenyl)-4,5-diphenylimidazole dimmer, 2-(o-methoxyphenyl)-4,5-diphenylimidazole dimmer, 2-(p-methoxyphenyl)-4,5-diphenylimidazole dimmer, 2-di(p-methoxyphenyl)-5-phenylimidazole dimmer and 2-(2,4-dimethoxyphenyl)-4,5-diphenylimidazole dimmer; benzyl dimethyl ketal, 2-2-benzyl-2-dimethylamino-1-(4-morpholinophenyl)butane-1-one, 2-methyl-1-[4-(methylthio)phenyl]-2-morpholino-1-propane, 2-hydroxy2-methyl-1-phenyl-propane-1-one, 1-[4-(2-hydroxyethoxy)-phenyl]-2-hydroxy-2-methyl-propane-1-one, phenanthrene, 9,10-phenthrenequinone; benzoins such as methylbenzoin and ethylbenzoin; acridine derivatives such as 9-phenylacridine and 1,7-bis(9,9′-acridinyl)heptane; bisacylphosphine oxide; and mixtures of these compounds. These compounds may be used alone or in combination.

In addition to these photopolymerization initiators, accelerators may be incorporated. Examples the accelerators include ethyl p-dimethylaminobenzoate, isoamyl p-dimethylaminobenzoate, ethanolamine, diethanolamine and triethanolamine.

These water soluble photopolymerization initiators may preferably be grafted at side chains for a hydrophilic main chain.

The polymeric compound of the present invention which has plural side chains on a hydrophilic main chain (backbone) and is capable of causing crosslinking bonds between the side chains by being irradiated with active energy rays, may cause crosslinking through crosslinking bonds among side chains of a main chain originally having a some degree of polymerization. Therefore, a molecular weight increasing effect per photon is remarkably larger in comparison with an ultraviolet-ray curable resin which causes polymerization through general chain reaction, whereby the very high curable sensitivity has been realized.

In the active energy ray cross-linkable polymer of the invention, the number of crosslinking points can be thoroughly controlled by the length of a hydrophilic main chain and the introduced amount of side chains. Therefore, the physical property of an ink layer can be controlled in correspondence with an object.

Various kinds of dyes and pigments known in ink-jet recording can be employed as colorants used for the ink-jet ink of the invention. Colorants usable in the invention are preferably anionic ones from the point of the combination with the ionicity of side chains of an active energy ray cross-linkable resin.

The present invention is characterized by jetting ink of the same color separately 2 times or more. The ink of the same color may has the same composition or different compositions.

### <Dye>

Examples of dyes usable in the invention are not specifically limited and include, for example, water-soluble dyes such as acid dyes, direct dyes, and reactive dyes, and disperse dyes, and anionic dyes are preferably used.

### <Water Soluble Dye>

Anionic water-soluble dyes usable in the invention include, for example, azo dyes, methine dyes, azomethine dyes, xanthene dyes, quinone dyes, phthalocyanine dyes, triphenylmethane dyes and diphenylmethane dyes. Examples of specific compounds thereof are shown below but are not limited to these.

### <C.I. Acid Yellow>

1, 3, 11, 17, 18, 19, 23, 25, 36, 38, 40, 42, 44, 49, 59, 61, 65, 67, 72, 73, 79, 99, 104, 110, 114, 116, 118, 121, 127, 129, 135, 137, 141, 143, 151, 155, 158, 159, 169, 176, 184, 193, 200, 204, 207, 215, 219, 220, 230, 232, 235, 241, 242, 246;

### <C.I. Acid Orange>

3, 7, 8, 10, 19, 24, 51, 56, 67, 74, 80, 86, 87, 88, 89, 94, 95, 107 108 116, 122, 127, 140, 142, 144, 149, 152, 156, 162, 166, 168;

### <C.I. Acid Red>

88, 97, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, 415;

### <C.I. Acid Violet>

17, 19, 21, 42, 43, 47, 48, 49, 54, 66, 78, 90, 97, 102, 109, 126;

### <C.I. Acid Blue>

1, 7, 9, 15, 23, 25, 40, 62, 72, 74, 80, 83, 90, 92, 103, 104, 112, 113, 114, 120, 127, 128, 129, 138, 140, 142, 156, 158, 171, 182, 185, 193, 199, 201, 203, 204, 205, 207, 209, 220, 221, 224, 225, 229, 230, 239, 249, 258, 260, 264, 278, 279, 280, 284, 290, 296, 298, 300, 317, 324, 333, 335, 338, 342, 350;

### <C.I. Acid Green>

9, 12, 16, 19, 20, 25, 27, 28, 40, 43, 56, 73, 81, 84, 104, 108, 109;

### <C.I. Acid Brown>

2, 4, 13, 14, 19, 28, 44, 123, 224, 226, 227, 248, 282, 283, 289, 294, 297, 298, 301, 355, 357, 413;

### <C.I. Acid Black>

1, 2, 3, 24, 26, 31, 50, 52, 58, 60, 63, 107, 109, 112, 119, 132, 140, 155, 172, 187, 188, 194, 207, 222;

### <C.I. Direct Yellow>

8, 9, 10, 11, 12, 22, 27, 28, 39, 44, 50, 58, 79, 86, 87, 98, 105, 106, 130, 132, 137, 142, 147, 153;

### <C.I. Direct Orange>

6, 26, 27, 34, 39, 40, 46, 102, 105, 107, 118;

### <C.I. Direct Red>

2, 4, 9, 23, 24, 31, 54, 62, 69, 79, 80, 81, 83, 84, 89, 95, 212, 224, 225, 226, 227, 239, 242, 243, 254;

### <C.I. Direct Violet>

9, 35, 51, 66, 94, 95;

### <C.I. Direct Blue>

1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290, 291;

### <C.I. Direct Green>

26, 28, 59, 80, 85;

### <C.I. Direct Brown>

44, 106, 115, 195, 209, 210, 222, 223;

### <C.I. Direct Black>

17, 19, 22, 32, 51, 62, 108, 112, 113, 117, 118, 132, 146, 154, 159, 169;

### <C.I. Reactive Yellow>

2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175, 176;

### <C.I. Reactive Orange>

1, 4, 5, 7, 11, 12, 13, 15, 16, 20, 30, 35, 56, 64, 67, 69, 70, 72, 74, 82, 84, 86, 87, 91, 92, 93, 95, 107;

### <C.I. Reactive Red>

2, 3, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 228, 235;

### <C.I. Reactive Violet>

1, 2, 4, 5, 6, 22, 23, 33, 36, 38;

### <C.I. Reactive Blue>

2, 3, 4, 5, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235, 236;

### <C.I. Reactive Green>

8, 12, 15, 19, 21;

### <C.I. Reactive Brown>

2, 7, 9, 10, 11, 17, 18, 19, 21, 23, 31, 37, 43, 46;

### <C.I. Reactive Black>

5, 8, 13, 14, 31, 34, 39;

### <C.I. Hood Black>

1 and 2.

### (Pigment)

Commonly known organic and inorganic pigments can be employed as a pigment usable in the invention, and anionic pigments are preferred. Examples thereof include organic pigments, such as azo pigments, e.g., azo lake, insoluble azo pigments, condensed azo pigments and chelate azo pigments; polycyclic pigments such as phthalocyanine pigments, perylene and perylene pigments, anthraquinone pigments, quinacridone pigments, dioxanedine pigments, thioindigo pigments, isoindolinone pigments, and quinophthaloni pigment; dye lakes such as an acid dye type lake; organic pigments such a nitro pigment, nitroso pigment, aniline black and a daylight fluorescent pigment; and inorganic pigments such as carbon black.

Specific examples of organic pigments are as follows.

Examples of magenta or red pigments include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178 and C.I. Pigment Red 122.

Examples of orange or yellow pigments include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128 and C.I. Pigment Yellow 138.

Examples of green or cyan pigments include C.I. Pigment Blue 15, C.I. Pigment Blue 15:2, C.I. Pigment Blue 15:3, C.I. Pigment Blue 16, C.I. Pigment Blue 60, and C.I. Pigment Green 7.

### <Dispersant>

To stably disperse pigments described above in the ink, water-soluble resins, as described below are preferably employed as a water-soluble polymer dispersant in terms of ejection stability.

Examples of a preferred water-soluble resin include styrene/acrylic acid/alkyl acrylate copolymer, styrene/acrylic acid copolymer, styrene/maleic acid copolymer, styrene/maleic acid/alkyl acrylate copolymer, styrene/methacrylic acid copolymer, styrene/methacrylic acid/alkyl acrylate copolymer, styrene/maleic acid half ester copolymer, vinylnaphthalene/acrylic acid copolymer, and vinylnaphthalene/maleic acid copolymer.

The water-soluble resin content is preferably from 0.1% to 10% by weight of the total amount of an ink, and more preferably 0.3% to 5%.

Water-soluble resins may be used alone or in combination.

### <Anionic Pigment>

Anionic pigments are usable in the invention. In terms of dispersion stability, a pigment, as described above which is dispersed with an anionic polymer dispersant or an anion-modified self-dispersing pigment is preferred as a form of an anionic pigment used in the invention.

The anionic polymer dispersant refers to a dispersing agent containing an anionic group which is obtained by neutralizing an acidic group included in the molecule with a basic compound. Examples of such a basic compound include an alkali metal hydroxide such as sodium hydroxide or potassium hydroxide, ammonia and amines such as an alkylamine, and alkanolamine. Amines are specifically preferred in the invention.

Any anionic polymer dispersant having a molecular weight of 1,000 or more is preferably used in the invention. Examples thereof include polyvinyl alcohols; polyvinyl pyrrolidones; acryl resin such as polyacrylic acid, acrylic acid/acryl nitrile copolymer, potassium acrylate/acryl nitrile copolymer, vinyl acetate/acrylic acid ester copolymer and acrylic acid/acrylic acid ester copolymer; styrene-acryl resin styrene-acrylic acid copolymer, styrene/methacrylic acid copolymer, styrene/methacrylic acid/acrylic acid ester copolymer, styrene/α-methylstyrene/acrylic acid copolymer and styrene/α-methylstyrene/acrylic acid/acrylic acid ester copolymer; styrene/maleic acid copolymer, styrene/maleic acid anhydride copolymer; vinylnaphthalene/acrylic acid copolymer, vinylnaphthalene/maleic acid copolymer; vinyl acetate type copolymer and its salt, such as vinyl acetate/ethylene copolymer, vinyl acetate/vinyl carboxylate ethylene copolymer, vinyl acetate/maleic acid ester copolymer, vinyl acetate/crotonic acid copolymer and vinyl acetate/acrylic acid copolymer; and resins containing a homopolymer, copolymer or terpolymer having an acidic functionality of carboxylic acid, sulfonic acid or phosphonic acid. Examples of a monomer providing such an acidic functionality include acrylic acid, methacrylic acid, crotonic acid, maleic acid, maleic acid anhydride, itaconic acid, mesaconic acid, fumaric acid, citraconic acid, vinylacetic acid, acryloxypropionic acid, vinylsulfonic acid, styrenesulfonic acid, 2-acrylamide-2-methylpropanesulfonic acid, allylsulfonic acid, allylphosphonic acid, vinylphosphonic acid and vinylsulfonic acid.

The anion-modified self-dispersing pigment used in the invention, refers to a particulate pigment with an anionic group on the particulate surface and dispersible without a dispersing agent. Thus, the anion-modified self-dispersing pigment is a pigment which is modified by neutralizing an acidic group-modified pigment with a basic compound, rendering the acidic group to be anionic, whereby the anionic self-dispersing pigment is dispersible in water without using a surfactant.

The particulate pigment with an anionic group on the particulate surface refers to pigment particles, the surface of which is directly modified with an acidic group or to an organic compound containing an organic pigment nucleus, to which an acidic group is bonded directly or via a joint.

Examples of an acidic group (also referred to as a polar group) include a sulfonic acid group, a carboxylic acid group, a phosphoric acid group, a boric acid group and a hydroxyl group. Of these groups, a sulfonic acid group and carboxylic acid group are preferred and a sulfonic acid group is more preferred.

Modifying agents for an acidic group include, for example, sulfur atom-containing treatment agents such as sulfuric acid, fuming sulfuric acid, sulfur trioxide, chlorosulfuric acid, fluorosulfuric acid, amidosulfuric acid, sulfonated pyridine salt and sulfamic acid, and calboxylating agents which oxidizes the pigment particle surface to introduce a carboxylic acid group, such as sodium hypochlorite and potassium hypochlorite. Of these, sulfonating agents such as sulfur trioxide, a sulfonated pyridine salt or sulfamic acid and a carboxylating agent are preferred. As a basic compound to neutralize an acidic group are cited an alkali metal hydroxide such as sodium hydroxide or potassium hydroxide, ammonia and amines such as an alkylamine or alkanolamine. Amines are specifically preferred in the invention.

The particulate pigment with a polar group on the particulate surface (i.e., pigment particles having a polar group on the surface of the particles) can be obtained by oxidizing the surface of the pigment particles with an appropriate oxidizing agent to introduce a polar group such as a sulfonic acid group or its salt to at least a part of the particle surface, as described in WO97/48769, JP-A Nos. 10-110129, 11-246807, 11-57458, 11-189739, 11-323232 and 2000-265094. More specifically, carbon black is oxidized by concentrated nitric acid or color pigments are oxidized with sulfamic acid, sulfonated pyridine salt or amidosulfuric acid in sulfolane or N-methyl-2-pyrrolidone. Oxidation proceeds through such a reaction and water-soluble materials are removed by purification, whereby a pigment dispersion is obtained. A sulfonic acid group which was introduced through oxidation onto the particle surface, may optionally be neutralized with a basic compound.

There are further cited a method in which pigment derivatives are allowed to adsorb onto the pigment particle surface through a milling treatment or the like, as described in JP-A Nos. 11-49974, 2000-273383 and 2000-303014, and a method in which a pigment is dissolved together with a pigment derivative in a solvent and allowed to precipitate in a poor solvent, as described in Japanese Patent Application No. 2000-377068, 2001-1495 and 2001-234966.

The polar group may be in the form of being free or a salt, or may combine with a counter ion to form a counter salt. Examples of such a counter ion include inorganic ions (e.g., lithium, sodium, potassium, magnesium, calcium, aluminum, nickel, ammonium) and organic ions (e.g., trimethylammonium, diethylammonium, pyridinium, triethanolammonium), of which monovalent counter ions are preferred.

A pigment dispersion usable for the ink-jet ink of the invention is preferably composed of pigment particles exhibiting an average particle size of not more than 500 nm, more preferably not more than 200 nm, still more preferably not less than 10 nm and not more than 200 nm, and further still more preferably not less than 10 nm and not more than 150 nm. An average pigment particle size of more than 500 nm results in an instable dispersion. An average pigment particle size of less than 10 nm results in poor stability of a pigment dispersion, leading to deteriorated storage stability of the ink.

The particle size of a particulate pigment dispersion can be measured by commercially available particle size measuring instruments employing light scattering, electrophoresis or laser Doppler effect. Alternatively, a transmission electron micrograph of at least 100 particles is subjected to a statistical treatment using an image analysis software such as Image-Pro (produced by Media Cybernetics) to determine the particle size.

Pigments can be dispersed by using a ball mill, a sand mill, atriter, a roll mill, an agitator, a Henschel mixer, a colloid mill, a ultrasonic homogenizer, a pearl mill, wet jet mill or a paint shaker.

In the ink-jet ink of the invention, the content of a water-dispersible or water-soluble pigment is preferably from 1% to 10% by weight of the total amount of the ink.

### <Aqueous Solvent>

An aqueous liquid medium is preferably used as a solvent usable in the invention. Such an aqueous liquid medium (or aqueous solvent) is preferably a mixture of water and water-soluble organic solvents. Examples of a preferable water-soluble organic solvent include alcohols (e.g., methanol, ethanol, propanol, isopropanol, butanol, isobutanol, secondary butanol, tertiary butanol), polyhydric alcohols (e.g., ethylene glycol, diethylene glycol, triethylene glycol, polyethylene glycol, propylene glycol, dipropylene glycol, polypropylene glycol, butylenes glycol, hexane-diol, pentane-diol, glycerin, hexane-triol, thiodiglycol), polyhydric alcohol ethers (e.g., ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, triethylene glycol monobutyl ether, ethylene glycol monophenyl ether, propylene glycol monophenyl ether), amines )e.g., ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, tetramethylpropylenediamine), amides (e.g., formamide, N,N-dimethylformamide, N,N-dimethylacetoamide), heterocycles (e.g., 2-pyrrolidone, N-methyl-2-pyrrolidone, cyclohexylpyrrolidone, 2-oxazolidone, 1,3-dimethyl-2-imidazolidinone) and sulfoxides (e.g., dimethylsulfoxide).

### <Surfactant>

Surfactants usable in the ink relating to the invention include, for example, nonionic surfactants such as polyoxyethylene alkyl ethers, polyoxyalkylene alkylphenylethers, acetylene glycols, and polyoxyethylene/polyoxypropylene block copolymers; glycerin esters, sorbitan esters, polyoxyethylene carboxylic acid amides and amine oxides. These surfactants are also usable as a dispersing agent of pigments.

### <Various Additives>

Commonly known additives may also be incorporated. Examples thereof include a brightener, a defoaming agent, a lubricant, an antiseptic agent, a thickening agent, an antistatic agent, a matting agent, a water-soluble polyvalent metal salt, an acid or base, a pH buffering agent, an antioxidant, a surface tension-controlling agent, a specific resistance-controlling agent, an anti-rusting agent and an inorganic pigment.

In the ink according to the present invention, in addition to the above additives, if needed, as required for objects to improve performances such as jetting stability, adaptability for a print head or a ink cartridge, preservation stability, image preserving ability, various well-known additives, for example, a viscosity modifier, a specific resistance adjusting agent, a coat layer forming agent, an ultraviolet absorber, an antioxidant, a fading inhibitor, an antifungal agent, an antirust agent, etc. may be selectively used. For example, oil droplet particles, such as liquid paraffin, dioctyl phthalate, tricresyl phosphate, and silicone oil; ultraviolet absorbers disclosed in Japanese Unexamined Patent Publication Nos. 57-74193, 57-87988, and 62-261476; fading inhibitors disclosed in Japanese Unexamined Patent Publication Nos. 57-74192, 57-87989, 60-72785, 61-146591, 1-95091, and 3-13376; fluorescent whitening agents disclosed in Japanese Unexamined Patent Publication Nos. 59-42993, 59-52689, 62-280069, 61-242871 and 4-219266 may be employed.

### <<Recording Medium>>

Paper includes coated paper and non-coated paper. Coated paper includes art paper in which the coated amount on one side is approximately 20 g/m², coated paper in which the coated amount on one side is approximately 10 g/m², light weight coated paper in which the coated amount on one side is approximately 5 g/m², ultra-light weight coated paper, matte finished coated paper, dull-coated paper of dull finished, and newsprint paper. Non-coated paper includes printing paper A employing 100% chemical pulp, printing paper B employing at least 70% chemical pulp, printing paper C employing from 40-70% chemical pulp, printing paper D employing at most 40% chemical pulp, and gravure paper which incorporates mechanical pulp and has been subjected to calendering. More details on paper are described in “Saishin Kamikako Binran (Handbook of Recent Paper Treatments)”, edited by Kako Binran Henshuiinkai, published by Tech. Times and “Insatsu Kogaku Binran (Printing Engineering Handbook)”, edited by Nihon Insatsu Gakkai (The Japanese Society of Printing Science and Technology).

As plain paper are used 80 to 200 μm thick non-coated types of paper which are considered as non-coated paper, special printing paper, and information paper. Examples of plain paper usable in the invention include high quality printing paper, medium quality printing paper, and low quality printing paper, thin printing paper, ultra-light weight coated printing paper, or special printing paper such as high quality colored paper, form paper sheets, PPC sheets, and other kinds such as information sheets. Specifically, there is available is paper described below and various modified/treated papers, but the present invention is not limited thereto.

There are cited HIGH QUALITY PAPER, HIGH QUALITY COLORED PAPER, RECYCLED PAPER, COPYING PAPER/COLOR, OCR PAPER, NON-CARBON PAPER/COLOR, SYNTHETIC PAPER such as YUPO 60, 80, and 110 MICRON, or YUPOCOAT 70 and 90 MICRON, others such as ONE SIDE ART PAPER 68 kg, COATED PAPER 90 kg, MATTE FORM PAPER 70, 90, and 110 kg, FOAMED PET 38 micron, and MITSUORIKUN (all available from Kobayashi Kirokushi Co., Ltd.), OK HIGH QUALITY PAPER, NEW OK HIGH QUALITY PAPER, SUN FLOWER, PHOENIX, OK ROYAL WHITE, HIGH QUALITY EXPORT PAPER (NPP, NCP, NWP, and ROYAL WHITE), OK BOOK PAPER, OK CREAM BOOK PAPER, CREAM HIGH QUALITY PAPER, OK MAP PAPER, OK ISHIKARI, KYUUREI, OK FORM, OKH, and NIP-N (all available from NEW OJI PAPER); KINO, TOKO, EXPORT HIGH QUALITY PAPER, SPECIAL DEMAND HIGH QUALITY PAPER, BOOK PAPER, BOOK PAPER L, PALE CREAM BOOK PAPER, PRIMARY SCHOOL SCIENCE TEXT BOOK PAPER, CONTINUOUS SLIP PAPER, HIGH QUALITY NIP PAPER, GINKAN, KINYO, KINYO (W), BRIDGE, CAPITAL, GINKAN BOOK PAPER, HARP, HARP CREAM, SK COLOR, SECURITY PAPER, OPERA CREAM, OPERA, KYP CARTE, SYLVIA HN, EXCELLENT FORM, and NPI FORM DX (all available from Nippon Paper Co., Ltd.); PEARL, KINRYO, PALE CREAM HIGH QUALITY PAPER, SPECIAL BOOK PAPER, SUPER BOOK PAPER, DIAFORM, and INK-JET FORM (all available from Mitsubishi Paper Mills, Ltd.); KINMO V, KINMO SW, HAKUZO, HIGH QUALITY PUBLISHING PAPER, CREAM KINMO, CREAM HAKUZO, SECURITY/TRADABLE COUPON PAPER, BOOK PAPER, MAP PAPER, COPY PAPER, and HNF (all available from Hokuetsu Paper Mills, Ltd.); SIORAI, TELEPHONE DIRECTORY COVER, BOOK PAPER, CREAM SHIORAI, CREAM SHIORAI MEDIUM ROUGH, CREAM SHIORAI HIGH ROUGH, and DSK (all available from Daishowa Paper Manufacturing Co., Ltd.); SENDAI MP HIGH QUALITY PAPER, KINKO, RAICHO HIGH QUALITY, HANGING PAPER, COLORED PAPER BASE PAPER, DICTIONARY PAPER, CREAM BOOK, WHITE BOOK, CREAM HIGH QUALITY PAPER, MAP PAPER, and CONTINUOUS SLIP PAPER (Chuetsu Paper & Pulp Co., Ltd.); OP KINO (CHUETSU), KINSA, REFERENCE PAPER, TRADABLE COUPON PAPER (WHITE)), FORM PRINTING PAPER, KRF, WHITE FORM, COLOR FORM, (K)NIP, FINE PPC, and KISHU INK-JET PAPER (all produced by Kishu Paper Co., Ltd.); TAIOU, BRIGHT FORM, KANT, KANT WHITE, DANTE, CM PAPER, DANTE COMIC, HEINE, PAPER BACKS PAPER, HEINE S, NEW AD PAPER, UTRILLO EXCEL, EXCEL SUPER A, KANTO EXCEL, EXCEL SUPER B, DANTE EXCEL, HEINE EXCEL, EXCEL SUPER C, EXCEL SUPER D, AD EXCEL, EXCEL SUPER E, NEW BRIGHT FORM, and NEW BRIGHT NIP (all available from Daio Paper Corporation); NICHIRIN, GETSURIN, UNREI, GINGA, HAKUUN, WAISU, GETURIN ACE, HAKUUN ACE, and UNKIN ACE (all produced by Japan Paper Industry Co., Ltd.); TAIOU, BRIGHT FORM and BRIGHT NIP (all available from Nagoya Pulp Co., Ltd.); BOTAN A, KINBATO, TOKU BOTAN, SHIROBOTAN A, SHIROBOTAN C, GINBATO, SUPER SHIROBOTAN A, PALE CREAM SHIROBOTAN, SPECIAL MEDIUM QUALITY PAPER, SHIROBATO, SUPER MEDIUM QUALITY PAPER, AO BATO, AKA BATO, KIN BATO M SNOW VISION, KIN BATO SNOW VISION, SHIRO BATO M, SUPER DX, HANAMASU O, AKA BATO M, and HK SUPER PRINTING PAPER (all manufactured by Honshu Paper Co., Ltd.); STAR LINDEN (A•AW), STAR ELM, STAR MAPLE, STAR LAUREL; STAR POPLAR, MOP, STAR CHERRY I, CHERRY I SUPER, CHERRY II SUPER, STAR CHERRY III, STAR CHERRY IV, CHERRY III SUPER, and CHERRY IV SUPER (all produced by Marusumi Paper Co., Ltd.); SHF (produced by Toyo Pulp Co., Ltd.); and TRP (produced by Tokai Pulp Co., Ltd.).

Further, employed as non-absorptive media may be any of the various films commonly employed. Examples include polyester film, polyolefin film, polyvinyl chloride film, and polyvinylidene chloride film. Further employed may be resin coated paper (RC paper prepared by covering both sides of a paper substrate with olefin resins) and YUPO paper, which is synthetic medium.

Further, various ink-jet recording media are prepared in such a manner that an absorptive or non-absorptive support is employed as a substrate and an ink receptive layer is formed on its surface. Some of ink receptive layers are composed of a coated layer, a swelling layer, and a minute void layer.

The swelling layer absorbs ink in such a manner that an ink receptive layer composed of water-soluble polymers swells. A minute void layer is composed of minute inorganic or organic particles at a diameter of the secondary particles of 20-200 nm and binders, and minute voids at about 100 nm absorb ink.

In recent years, to produce photographic images, preferably employed as a substrate, are ink-jet recording media in which the above minute void layer is provided on RC paper which is prepared by covering both sides of a paper substrate with olefin resins.

### EXAMPLE

Hereafter, the present invention will be explained concretely with reference to examples, however, the present invention is not limited to these examples. In this connection, the terms “part” and “%” are used in the examples, as long as there is no counter definition in particular, the terms represent “parts by weight” or “percent by weight (or wt %) ”.

### <<Synthesis of Active Energy Ray Cross-Linkable Polymeric Compounds>>

### (Synthesis of Active Energy Ray Cross-Linkable Polymeric Compound 1)

Active energy ray cross-linkable polymeric compound 1 was synthesized in accordance with the following methods.

Into a reaction container, 58 g of glycidyl methacrylates, 42 g of p-hydroxybenzaldehyde, 3 g of pyridine, and 1 g of N-nitrosophenyl hydroxyamine ammonium salt were put, and were agitated in a water bath of 80° C. for 8 hours.

Subsequently, 45 g of saponified polyvinyl acetate having an average polymerization degree of 2200 and a saponification rate of 88% was dispersed into 225 g of ion-exchange water. Then, into this solution, 4.5 g of phosphoric acid and p-(3-methacryloxy 2-hydroxypropyloxy) benzaldehyde obtained by the above-mentioned reaction were added so that a denaturation rate to polyvinyl alcohol becomes 3.0 mol %, and the resultant solution was agitated at 90° C. for 6 hours. After the obtained solution was cooled to a room temperature, 30 g of basic ion exchange resins were added, and stirred for 2 hours.

Then, the ion exchange resins were filtered from the solution, and Irgacure 2959 (Ciba Speciality Chemicals Corp.) as a photopolymerization initiator was mixed at a rate of 0.5 g to 100 g of 15% aqueous solutions, thereafter the resultant solution was diluted with ion exchange water, whereby a 10% of active energy ray cross-linkable polymeric compound 1 aqueous solution was obtained.

### (Synthesis of Active Energy Ray Cross-Linkable Polymeric Compound 2)

In the synthesis of the above-mentioned active light cross-linkable polymeric compound 1, a 10% of active energy ray cross-linkable polymeric compound 2 aqueous solution was obtained with the same way except that saponified polyvinyl acetate having an average polymerization degree of 330 and a saponification rate of 88% was used as the saponified polyvinyl acetate, and the additive amount of p-(3-methacryloxy 2-hydroxypropyloxy) benzaldehyde was adjusted suitably so as to make the denaturation rate to be 3.0 mol %.

### <<Preparation of Ink Sets>>

Ink sets 1 to 3 were prepared in accordance with the following methods.

### [Preparation of Pigment Dispersion]

### (Preparation of Magenta Pigment Dispersion)

The following additives were mixed and dispersed by the use of a sand grinder in which 0.6 mm zirconia beads were filled up with a volume rate of 50%, whereby a magenta pigment dispersion having a magenta pigment content of 15% was prepared. The average particle size of the magenta pigment particles contained in this magenta pigment dispersion was 120 nm. Incidentally, the particle size measurement was conducted by the use of Zetasizer 1000HS produced by Malvern Corporation.

| | |
|---|---|
| C.I pigment red 122 | 15 parts |
| Johnkrill 61 (styrene acrylic resin dispersant, | 10 parts |
| produced by Johnson Corp., a solid content of 30%) | |
| Glycerol | 15 parts |
| Ion exchange water | 67 parts |

### (Preparation of Black Pigment Dispersion)

Carbon black self-dispersion produced by Cabot Corp.: Cabojet300 was diluted with ion exchange water, whereby a black pigment dispersion having a carbon black content of 15% was prepared. The average particle size of the black pigment particles contained in this black pigment dispersion was 130 nm. Incidentally, the particle size measurement was conducted by the use of Zetasizer 1000HS produced by Malvern Corporation.

### (Preparation of Yellow Pigment Dispersion)

The following additives were mixed and dispersed by the use of a sand grinder in which 0.6 mm zirconia beads were filled up with a volume rate of 50%, whereby a yellow pigment dispersion having a yellow pigment content of 15% was prepared. The average particle size of the yellow pigment particles contained in this yellow pigment dispersion was 110 nm. Incidentally, the particle size measurement was conducted by the use of Zetasizer 1000HS produced by Malvern Corporation.

| | |
|---|---|
| C.I pigment yellow 74 | 15 parts |
| Johnkrill 61 (styrene acrylic resin dispersant, | 10 parts |
| produced by Johnson Corp., a solid content of 30%) | |
| Glycerol | 15 parts |
| Ion exchange water | 67 parts |

The following additives were mixed and dispersed by the use of a sand grinder in which 0.6 mm zirconia beads were filled up with a volume rate of 50%, whereby a cyan pigment dispersion having a cyan pigment content of 15% was prepared. The average particle size of the cyan pigment particles contained in this cyan pigment dispersion was 130 nm. Incidentally, the particle size measurement was conducted by the use of Zetasizer 1000HS produced by Malvern Corporation.

| | |
|---|---|
| C.I pigment blue 15 | 15 parts |
| Johnkrill 61 (styrene acrylic resin dispersant, | 10 parts |
| produced by Johnson Corp., a solid content of 30%) | |
| Glycerol | 15 parts |
| Ion exchange water | 67 parts |

### [Preparation of ink set 1]

(Preparation of magenta pigment ink 1)

| | | |
|---|---|---|
| Magenta pigment dispersion (solid content of 15%) | 20 | parts |
| Aqueous solution of active energy ray cross-linkable | 28 | parts |
| polymeric compound 1 (solid content of 10%) | | |
| Propylene glycol | 30 | parts |
| Ethylene glycol | 10 | parts |
| Olfin E1010 (produced by Nishin Kagaku Co., Ltd.) | 1 | part |
| Antifungal agent: Proxel GXL (made by Abishia Corp.) | 0.3 | parts |

In addition to the above components, ion exchange water was added so as to make the ink to 100 parts.

### (Preparation of Black Ink 1)

In the preparation of the above-mentioned magenta pigment ink 1, black pigment ink 1 was obtained with the same way except that a black pigment dispersion was used in place of the magenta pigment dispersion.

### (Preparation of Yellow Pigment Ink 1)

In the preparation of the above-mentioned magenta pigment ink 1, yellow pigment ink 1 was obtained with the same way except that an yellow pigment dispersion was used in place of the magenta pigment dispersion.

### (Preparation of Cyan Pigment Ink 1)

In the preparation of the above-mentioned magenta pigment ink 1, cyan pigment ink 1 was obtained with the same way except that a cyan pigment dispersion was used in place of the magenta pigment dispersion.

The prepared magenta pigment ink 1, black pigment ink 1, yellow pigment ink 1, and cyan pigment ink 1 were made as ink set 1.

### [Preparation of Ink Set 2]

In the preparation of the above-mentioned magenta pigment ink 1, black pigment ink 1, yellow pigment ink 1, and cyan pigment ink 1, magenta pigment ink 2, black pigment ink 2, yellow pigment ink 2, and cyan pigment ink 2 were prepared with the same way except that an aqueous solution of 10% of active energy ray cross-linkable polymeric compound 2 was used in place of the aqueous solution of 10% of active energy ray cross-linkable polymeric compound 1, and the prepared magenta pigment ink 2, black pigment ink 2, yellow pigment ink 2, and cyan pigment ink 2 were made as ink set 2.

### [Preparation of the Ink Set 3]

(Preparation of magenta pigment ink 3)

| | |
|---|---|
| Magenta pigment dispersion (solid content of 15%) | 20 parts |
| Aqueous ultraviolet curable urethane acrylate resin | 5 parts |
| emulsion (solid content of 40%, produced by Taisei Kakou | |
| Co., brand name: WBR-839) | |
| 2-pyrrolidinone | 15 parts |
| Ethylene glycol | 10 parts |
| Olfin E1010 (produced by Nishin Kagaku Co., Ltd.) | 1 part |
| Antifungal agent: Proxel GXL (made by Abishia Corp.) | 0.3 parts |

In addition to the above components, ion exchange water was added so as to make the ink to 100 parts.

### (Preparation of Black Pigment Ink 3, Yellow Pigment Ink 3, and Cyan Pigment Ink 3)

In the preparation of the above-mentioned magenta pigment ink 3, black pigment ink 3, yellow pigment ink 3, and cyan pigment ink 3 were obtained with the same way except that black pigment dispersion, yellow pigment dispersion, and cyan pigment dispersion were used respectively in place of magenta pigment dispersion.

The prepared magenta pigment ink 3, the black pigment ink 3, the yellow pigment ink 3, and the cyan pigment ink 3 were made as ink set 3.

### <<Image Recording>>

### [Image Recording Method 1]

Image recording was performed by the use of a line head type ink-jet recording device constituted with two ink-jet recording head units shown in FIG. 3.

Each ink-jet recording head constituting the two ink-jet recording head units was a piezo type ink-jet recording head having a nozzle diameter of 25 μm, 512 nozzles, a minimum droplet amount of 12 pl, and a nozzle density of 180 dpi (in this connection, the term “dpi” represents the number of dots per 2.54 mm). The ink-jet recording heads were arranged to constitute an ink-jet recording head unit HU1 (ink jet recording heads HK1, HC1, HM1, HY1) and an ink-jet recording head unit HU2 (ink jet recording heads HK2, HC2, HM2, HY2). The ink-jet recording head unit HU1 and the ink-jet recording head unit HU2 were arranged in a direction perpendicular the conveying direction of a recording medium to cover a printing width respectively, whereby the ink-jet recording head unit HU1 and the ink-jet recording head unit HU2 were made to a line head type ink-jet recording head unit having the maximum recording density of 720×720 dpi respectively.

As a light source for irradiating active energy rays, 160 W/cm metal halide lamps (MAN200 (N) L, produced by Japan Storage Battery Co., Ltd.) were set up so as to constitute a line head type active energy ray irradiating means (light irradiating device 5). Two sets of the light source were prepared and arranged as shown in FIG. 1. Thus, the line head type ink-jet recording device was prepared.

The ink set 1 was installed into the ink-jet recording head units HU1 and HU2 shown in FIG. 3, images were recorded with a conveying speed of 300 mm/second, and were irradiated with active energy rays from the active energy ray irradiating light source.

The printing order (ink droplet reaching order) of each ink was conducted as follows in accordance with the ink droplet reaching order for ink dots shown in FIG. 2. The ink dots 1 and the ink dots 4 were printed by the ink-jet recording heads HK1, HC1, HM1, and HY1 constituting the ink-jet recording head unit HU1, and these ink dots were irradiated with active energy rays by the light irradiating devices 51. Subsequently, the ink dots 2 and the ink dots 3 were printed by the ink-jet recording heads HK2, HC2, HM2, and HY2 constituting the ink-jet recording head unit HU2, and then these ink dots were irradiated with active energy rays respectively by the light irradiating devices 52, whereby the formed images were cured or hardened.

The image formation was conducted in accordance with the above method and made as Image recording method 1.

### [Image Recording Method 2]

Image recording method 2 was conducted as the same way in the image recording method 1 except that a flat panel heater was attached to a conveyance part of the line head type ink jet recording device shown in FIG. 3 used in the above-mentioned image recording method 1, and the surface temperature was set at 60° C., further an ink set installed in each ink-jet recording head unit and a conveying speed for a recording medium were changed as indicated in Table 1.

### [Image Recording Method 3]

Image recording method 3 was conducted as the same way in the image recording method 1 except that the positions of an ink dot 1 and an ink dot 4 were printed by the ink-jet recording heads HC1 and HY1 of the ink-jet recording head unit HU1, and the positions of an ink dot 2 and an ink dot 3 were printed by the ink-jet recording heads HK1 and HM1. Further, the positions of an ink dot 2 and an ink dot 3 were printed by the ink-jet recording heads HC2 and HY2 of the ink-jet recording head unit HU2, and the positions of an ink dot 1 and an ink dot 4 were printed by the ink-jet recording heads HK2 and HM2.

### [Image Recording Method 4]

Image recording was performed by the use of the line head type ink-jet recording device constituted with four ink-jet recording head units shown in FIG. 5, and this image recording was made Image recording method 4.

Each ink-jet recording head constituting the four ink-jet recording head units was a piezo type ink-jet recording head having a nozzle diameter of 25 μm, 512 nozzles, a minimum droplet amount of 12 μl, and a nozzle density of 180 dpi (in this connection, the term “dpi” represents the number of dots per 2.54 mm). The ink-jet recording heads were arranged to constitute an ink-jet recording head unit Hu1 (ink jet recording heads HK1, HC1, HM1, HY1), an ink-jet recording head unit HU2 (ink jet recording heads HK2, HC2, HM2, HY2), an ink-jet recording head unit HU3 (ink jet recording heads HK3, HC3, HM3, HY3) and an ink-jet recording head unit HU4 (ink jet recording heads HK4, HC4, HM4, HY4). These ink-jet recording head unit HU1, HU2, HU3, and HU4 were arranged in a direction perpendicular the conveying direction of a recording medium to cover a printing width respectively, whereby The ink-jet recording head unit HU1 and the ink-jet recording head unit HU2 were made to a line head type ink-jet recording head unit having the maximum recording density of 360×360 dpi respectively.

Nozzles of each of these ink-jet recording head units are arranged such that as shown in FIG. 6, the position of each of the nozzles of the ink-jet recording head HK2, HC2, HM2, HY2 is deviated by 720 dpi in the direction perpendicular to the conveying direction from the position of the corresponding one of the nozzles of the ink jet recording head HK1, HC1, HM1, HY1. And also the position of each of the nozzles of the ink-jet recording head HK4, HC4, HM4, HY4 is deviated by 720 dpi in the direction perpendicular to the conveying direction from the position of the corresponding one of the nozzles of the ink-jet recording head HK3, HC3, HM3 and HY3. As a light source (light irradiating device 5) for irradiating active energy rays, 160 W/cm metal halide lamps (MAN200 (N) L, produced by Japan Storage Battery Co., Ltd.) are set up so as to constitute a line head type active energy ray irradiating means. Four sets of the light source were prepared and arranged as shown in FIG. 5. Thus, the line head type ink-jet recording device was prepared.

The ink set 2 was installed into respective ink-jet recording heads of each of the ink-jet recording head units shown in FIG. 5. After images were recorded with a conveying speed of 400 mm/second by each of the ink-jet recording head units, the images were irradiated with active energy rays from respective active energy ray irradiating light sources.

The printing order (ink droplet reaching order) of each ink was conducted in accordance with the ink droplet reaching order for dots shown in FIG. 2. Images were formed in such a manner that the ink dots 1 were printed by the ink-jet recording head unit HU1 (the ink-jet recording heads HK1, HC1, HM1, and HY1) and these ink dots 1 were irradiated with active energy rays by the light irradiating devices 51, the ink dots 2 were printed by the ink-jet recording head unit HU2 (the ink-jet recording heads HK2, HC2, HM2, and HY2) and these ink dots 2 were irradiated with active energy rays by the light irradiating devices 52, the ink dots 3 were printed by the ink-jet recording head unit HU3 (the ink-jet recording heads HK3, HC3, HM3, and HY3) and these ink dots 3 were irradiated with active energy rays by the light irradiating devices 53, and the ink dots 4 were printed by the ink-jet recording head unit HU4 (the ink-jet recording heads HK4, HC4, HM4, and HY4) and these ink dots 4 were irradiated with active energy rays by the light irradiating devices 54.

### [Image Recording Method 5]

Image recording method 5 was conducted as the same way in the image recording method 4 except that a flat panel heater was attached to a conveyance part of the line head type ink jet recording device shown in FIG. 5 used in the above-mentioned image recording method 4, and the surface temperature was set at 60° C., further an ink set installed in each ink-jet recording head unit and a conveying speed for a recording medium were changed as indicated in Table 1.

### [Image Recording Method 6]

Image recording was performed by the use of the line head type ink-jet recording device equipped with one ink-jet recording head unit shown in FIG. 1 and one light irradiating device, and this image recording was made as Image recording method 6.

Each of the ink-jet recording heads HK, HC, HM, and HY constituting the two ink-jet recording head unit HU was a piezo type ink-jet recording head having a nozzle diameter of 25 μm, 512 nozzles, a minimum droplet amount of 12 pl, and a nozzle density of 180 dpi (in this connection, the term “dpi” represents the number of dots per 2.54 mm). The ink-jet recording heads were arranged in a direction perpendicular the conveying direction of a recording medium to cover a printing width respectively, thereby forming a line head type ink-jet recording head having the maximum recording density of 720×720 dpi respectively. As a light source (light irradiating device 5) for irradiating active energy rays, 160 W/cm metal halide lamps (MAN200 (N) L, produced by Japan Storage Battery Co., Ltd.) are set up so as to constitute a line head type active energy ray irradiating means. Thus, the line head type ink-jet recording device was prepared.

The ink set 3 was installed into respective ink-jet recording heads constituting the ink-jet recording head unit shown in FIG. 1. Images were recorded with a conveying speed of 200 mm/second, and were irradiated with active energy rays from the active energy ray irradiating light source.

The printing order (ink droplet reaching order) of each ink was conducted as follows in accordance with the ink droplet reaching order for ink dots shown in FIG. 2. The ink dots 1 and the ink dots 3 were printed by the ink-jet recording heads HK, HC, HM, and HY constituting the ink-jet recording head unit HU, subsequently, the ink dots 2 and the ink dots 4 were printed by the ink-jet recording heads HK, HC, HM, and HY, and thereafter these ink dots 1, 2, 3, and 4 were irradiated with active energy rays by the light irradiating devices 5.

### [Image Recording Method 7]

Image recording was performed by the use of the line head type ink-jet recording device in which an ink-jet recording head and a light irradiating device are structured to form a pair as shown in FIG. 4, and this image recording was made as Image recording method 7.

Each of the ink-jet recording heads HK, HC, HM, and HY was a piezo type ink-jet recording head having a nozzle diameter of 25 μm, 512 nozzles, a minimum droplet amount of 12 pl, and a nozzle density of 180 dpi (in this connection, the term “dpi” represents the number of dots per 2.54 mm). The ink-jet recording heads were arranged in a direction perpendicular the conveying direction of a recording medium to cover a printing width respectively, thereby forming a line head type ink-jet recording head having the maximum recording density of 720×720 dpi respectively.

As a light source for irradiating active energy rays, 160 W/cm metal halide lamps (MAN200 (N) L, produced by Japan Storage Battery Co., Ltd.) are set up so as to constitute a line head type active energy ray irradiating means. Four sets of this device were prepared and arranged as shown in FIG. 4. Thus, the line head type ink-jet recording device was prepared.

The ink set 3 was installed into respective ink-jet recording heads shown in FIG. 4. Images were recorded with a conveying speed of 200 mm/second, and were irradiated with active energy rays from the active energy ray irradiating light source.

The printing order (ink droplet reaching order) of each ink was conducted as follows in accordance with the ink droplet reaching order for ink dots shown in FIG. 2. The ink dots 1 and the ink dots 3 were printed by the ink-jet recording head HY, subsequently, the ink dots 2 and the ink dots 4 were printed by the ink-jet recording head HY, and thereafter these ink dots 1, 2, 3, and 4 were irradiated with active energy rays by the light irradiating devices SY. Next, the ink dots 1 and the ink dots 3 were printed by the ink-jet recording head HM, subsequently, the ink dots 2 and the ink dots 4 were printed by the ink-jet recording head HM, and thereafter these ink dots 1, 2, 3, and 4 were irradiated with active energy rays by the light irradiating devices 5M. Next, the ink dots 1 and the ink dots 3 were printed by the ink-jet recording head HC, subsequently, the ink dots 2 and the ink dots 4 were printed by the ink-jet recording head HC, and thereafter these ink dots 1, 2, 3, and 4 were irradiated with active energy rays by the light irradiating devices 5C. Finally, the ink dots 1 and the ink dots 3 were printed by the ink-jet recording head HK, subsequently, the ink dots 2 and the ink dots 4 were printed by the ink-jet recording head HK, and thereafter these ink dots 1, 2, 3, and 4 were irradiated with active energy rays by the light irradiating devices 5K.

### [Image Recording Method 8]

Image recording was conducted by the use of a drum printing type ink-jet printer shown in FIG. 7.

Each ink-jet recording head constituting an ink-jet recording head unit CHU was a piezo type ink-jet recording head having a nozzle diameter of 25 μm, 512 nozzles, a minimum droplet amount of 12 pl, and a nozzle density of 180 dpi (in this connection, the term “dpi” represents the number of dots per 2.54 mm). The ink-jet recording heads were arranged to constitute the ink-jet recording head unit CHU (ink jet recording heads CHK, CHC, CHM, CHY) in a direction perpendicular the conveying direction of a recording medium to cover a printing width respectively, whereby the ink-jet recording head unit CHU was made to a line head type ink-jet recording head unit having the maximum recording density of 720×720 dpi respectively.

As a light source for irradiating active energy rays, 160 W/cm metal halide lamps (MAN200 (N) L, produced by Japan Storage Battery Co., Ltd.) was set up so as to constitute a line head type active energy ray irradiating means (light irradiating device CL) and arranged as shown in FIG. 7. Thus, the line head type ink-jet recording device was prepared.

The ink set 3 was installed into the ink-jet recording head units CHU shown in FIG. 7, images were recorded with a conveying speed of 350 mm/second, and were irradiated with active energy rays from the active energy ray irradiating light source.

The printing order (ink droplet reaching order) of each ink droplet was conducted as follows in accordance with the ink droplet reaching order for ink dots shown in FIG. 2. During the rotation of the drum 11 at the first time, the ink dots 1 and the ink dots 4 were printed by the ink-jet recording heads CHK, CHC1, CHM, and CHY constituting the ink-jet recording head unit CHU, and these ink dots were irradiated with active energy rays by the light irradiating device CL. Subsequently, during the rotation of the drum 11 at the second time, the ink dots 2 and the ink dots 3 were printed by the same ink-jet recording heads CHK, CHC, CHM, and CHY, and then these ink dots were irradiated with active energy rays respectively by the light irradiating device CL, whereby the formed images were cured or hardened.

The image formation was conducted in accordance with the above method and made as Image recording method 8.

### <<Evaluation of Formed Images>>

Each image formed by the above-mentioned Image recording methods 1 to 8 was evaluated in accordance with the following methods.

### [Evaluation of Banding Resistance]

In accordance with each of above-mentioned image recording methods, a solid red image (10 cm×10 cm) formed by the use of the magenta pigment and the yellow pigment ink was outputted on a coated paper (O.K. topcoat, produced by Oji Paper Co., Ltd.) and a PET (polyethylene terephthalate) film as a recording medium, thereafter, presence or absence of banding on the formed solid image was checked by visual observation, and banding resistance was evaluated in accordance with the following criterion.

A: No banding was observed.

B: Weak streaks perpendicular to the conveying direction slightly occurred.

C: Streaks perpendicular to the conveying direction were observed lightly overall, however, these streaks were in a permissible range as practical use.

D: Streaks perpendicular to the conveying direction were clearly observed.

E: Severe patchy patterns were observed overall, and these were not permissible as practical use.

### [Evaluation of Color Bleeding Resistance]

On a solid red image (10 cm×10 cm) formed on a coated paper (O.K. topcoat, produced by Oji Paper Co., Ltd.) as a recording medium in accordance with each of above-mentioned image recording methods by the use of the magenta pigment and the yellow pigment ink, the printing points of the black pigment were changed so as to arrange black characters on image patterns to be outputted.

Presence or absence of color mixture on the formed character image was checked by visual observation, and color bleeding resistance was evaluated in accordance with the following criterion.

A: No color mixture was observed.

B: Although color mixture was observed slightly, the characters of 7 points were confirmed.

C: Although color mixture was observed lightly, the characters of 9 points were confirmed and the color mixture was in a permissible range as practical use.

D: Color mixture was severe and only the characters of 12 point were confirmed.

E: Color mixture was quite severe and even the characters of 12 point were not confirmed.

### [Evaluation of Brilliance]

In accordance with each above-mentioned image recording method, “N2 Flowers (JIS9204-2000)” as an outputted image was outputted on A4 type coated paper (S A Kanefuji, made by Oji Paper Co., Ltd.) as a recording medium, thereby producing evaluation image samples. As a panelist of image evaluation, 20 persons were selected arbitrarily and visual evaluation for brilliance was performed. An offset-printing image was formed on the same recording medium by offset printing (Printmaster GTO52 produced by Heidelberg company), and the offset-printing image was evaluated comparatively as a reference sample.

Among the panelists of 20 persons, the number of persons having judged the brilliance of test sample equivalent to that of the reference sample of the offset-printing image was counted, and the evaluation for brilliance was performed in accordance with the following criterion.

A: The number of persons having judged the brilliance of test sample equivalent to that of the reference sample of the offset-printing image is 16 or more.

B: The number of persons having judged the brilliance of test sample equivalent to that of the reference sample of the offset-printing image is 13 to 15.

C: The number of persons having judged the brilliance of test sample equivalent to that of the reference sample of the offset-printing image is 9 to 12.

D: The number of persons having judged the brilliance of test sample equivalent to that of the reference sample of the offset-printing image is 4 to 8.

E: The number of persons having judged the brilliance of test sample equivalent to that of the reference sample of the offset-printing image is 3 or less.

Each of the evaluation results obtained by the above is shown in Table 1.

TABLE 1

| | | Figure | | | | | | | |
|---|---|---|---|---|---|---|---|---|---|
| | | No. of | Presence | | | | | | |
| Image | | the used | or | | Banding | | | | |
| recording | Ink | ink-jet | absence | Conveying | resistance | | Color | | |
| method | set | recording | of pre- | speed | Coat | | bleeding | | |
| No. | No. | device | heating | (mm/sec) | paper | PET | resistance | Glossiness | Remarks |
| 1 | 1 | FIG. 3 | Absence | 300 | A | A | A | B | Inv. |
| 2 | 2 | FIG. 3 | Presence | 350 | A | A | A | A | Inv. |
| 3 | 1 | FIG. 3 | Absence | 300 | A | A | A | A | Inv. |
| 4 | 2 | FIG. 5 | Absence | 400 | A | A | A | B | Inv. |
| 5 | 3 | FIG. 5 | Presence | 200 | B | C | C | B | Inv. |
| 6 | 3 | FIG. 1 | Absence | 200 | D | E | D | E | Com. |
| 7 | 3 | FIG. 4 | Absence | 200 | D | D | D | D | Com. |
| 8 | 3 | FIG. 7 | Absence | 350 | A | A | A | B | Inv. |

As being clear from the results indicated in Table 1, the images formed by the use of the ink jet recording device structured by the present invention is excellent in the banding resistance at the time of using a low absorptivity recording medium and an unabsorbent recording medium, and also excellent in the color bleeding resistance and the brilliance at the time of using a low absorptivity recording medium to the images of comparative examples.

What is claimed is:

1. An ink-jet recording method of recording an image on a recording medium by jetting from a line head type ink-jet recording head ink droplets which are curable by being irradiated with active energy rays, comprising:
a conveying step of conveying the recording medium in a conveying direction;
a first jetting step of jetting ink droplets to form first ink dots on the recording medium;
a first irradiating step of irradiating active energy rays onto the first ink dots formed on the recording medium;
a second jetting step of jetting ink droplets having the same color as that of the first ink dots at a downstream position of the first jetting step in terms of the conveying direction to form second ink dots so as to partially overlap on the first ink dots; and
a second irradiating step of irradiating active energy rays onto the second ink dots formed on the recording medium.

2. The ink-jet recording method described in claim 1, wherein the first ink dots are formed in the direction perpendicular to the conveying direction at the first jetting step such that the first ink dots are not overlapped to each other and the second ink dots are formed on the gaps among the first ink dots so as to form line-shaped ink dots in the direction perpendicular to the conveying direction.

3. The ink-jet recording method described in claim 1, wherein the first ink dots are formed in the conveying direction at the first jetting step such that the first ink dots are not overlapped to each other and the second ink dots are formed on the gaps among the first ink dots so as to form line-shaped ink dots in the conveying direction.

4. The ink-jet recording method described in claim 1, wherein the first jetting step and the second jetting step form line-shaped ink dots in the conveying direction respectively.

5. The ink-jet recording method described in claim 1, wherein the arrangement of the first ink dots formed in the direction perpendicular to the conveying direction at the first jetting step is deviated by 0.5 pitch from the arrangement of the second ink dots formed in the direction perpendicular to the conveying direction at the second jetting step.

6. The ink-jet recording method described in claim 1, wherein the first jetting step superimposes at least two different color inks so as to form first color-mixed ink dots, the first irradiating step irradiates active energy rays onto the first color-mixed ink dots, the second jetting step forms second color-mixed ink dots having the same color as that of the first mixed ink dots at positions adjacent to the first color-mixed ink dots, and the second irradiating step irradiates active energy rays onto the second color-mixed ink dots.

7. The ink-jet recording method described in claim 1, wherein the ink droplets include water and a polymeric compound which is curable or crosslinkable by being irradiated with active energy rays.

8. The ink-jet recording method described in claim 7, wherein the polymeric compound is a polymeric compound which has plural side chains on a hydrophilic main chain and is able to crosslink between the side chains by being irradiated with active energy rays.

9. The ink-jet recording method described in claim 8, wherein in the polymeric compound, the hydrophilic main chain is a saponified product of polyvinyl acetate, the degree of saponification is 77% to 99%, and the degree of polymerization is 200 to 500.

10. The ink-jet recording method described in claim 8, wherein in the polymeric compound, the modification rate of the side chains to the hydrophilic main chain is 0.8 mol % or more and 5 mol % or less.

11. The ink-jet recording method described in claim 8, wherein the polymeric compound further includes a photopolymerization initiator.

12. The ink-jet recording method described in claim 1, wherein the ink droplets correspond to at least one kind ink constituting an ink-jet ink set consisting of two or more kinds of ink-jet inks different in hue.

13. The ink-jet recording method described in claim 1, wherein the recording medium is a low absorptivity recording medium or an unabsorbent recording medium.

14. The ink-jet recording method described in claim 1, further comprising:
a heating step of heating the recording medium from the back side of the recording medium during recording or before and after recording.

15. An ink-jet recording apparatus for recording an image on a recording medium by jetting ink droplets which are curable by being irradiated with active energy rays, comprising:
a conveying section to convey the recording medium in a conveying direction;
a first line head to jet ink droplets so as to form first ink dots on the recording medium;
a first irradiating section to irradiate active energy rays onto the first ink dots formed on the recording medium;
a second line head to jet ink droplets having the same color as that of the first ink dots at a downstream position of the first line head in terms of the conveying direction to form second ink dots so as to partially overlap on the first ink dots; and
a second irradiating section to irradiate active energy rays onto the second ink dots formed on the recording medium.

16. The ink-jet recording apparatus described in claim 15, wherein the first line head forms the first ink dots in the direction perpendicular to the conveying direction such that the first ink dots are not overlapped to each other and the second line head forms the second ink dots on the gaps among the first ink dots so as to form line-shaped ink dots in the direction perpendicular to the conveying direction.

17. The ink-jet recording apparatus described in claim 15, wherein the first line head forms the first ink dots in the conveying direction such that the first ink dots are not overlapped to each other and the second line head forms the second ink dots on the gaps among the first ink dots so as to form line-shaped ink dots in the conveying direction.

18. The ink-jet recording apparatus described in claim 15, wherein the first line head and the second line head form line-shaped ink dots in the conveying direction respectively.

19. The ink-jet recording apparatus described in claim 15, wherein the arrangement of the first ink dots formed in the direction perpendicular to the conveying direction by the first line head is deviated by 0.5 pitch from the arrangement of the second ink dots formed in the direction perpendicular to the conveying direction by the second line head.

20. The ink-jet recording apparatus described in claim 15, wherein the first line head includes at least two different color ink line heads and the second line head includes color ink line heads having the same colors of the first line head.

21. The ink-jet recording apparatus described in claim 15, wherein the conveying section includes a conveying belt.

22. The ink-jet recording apparatus described in claim 15, wherein the conveying section includes a rotatable drum.

23. The ink-jet recording apparatus described in claim 15, wherein a common line head and a common irradiating section are mounted on the rotatable drum, and wherein during the first rotation of the rotatable drum, the common line head and the common irradiating section act as the first line head and the first irradiating section and form the first ink dots, and subsequently during the second rotation of the rotatable drum, the common line head and the common irradiating section act as the second line head and the second irradiating section and form the second ink dots.

24. The ink-jet recording apparatus described in claim 15, further comprising:
a heating section to heat the recording medium from the back side of the recording medium during recording or before and after recording.
